(19) United States
(12) Patent Application Publication
(10) Pub. No.: US 2026/0204924 A1
(43) Pub. Date: Jul. 16, 2026

(54) METHOD FOR OPERATING AN ENERGY SUPPLY PLANT, ENERGY SUPPLY PLANT HAVING A PLURALITY OF INVERTERS AND INVERTER

(71) Applicant: SMA Solar Technology AG, Niestetal (DE)

(72) Inventors: Andreas Knobloch, Kassel (DE); Simon Scheurich, Kassel (DE)

(21) Appl. No.: 19/417,996

(22) Filed: Dec. 12, 2025

Related U.S. Application Data
(63) Continuation of application No. PCT/EP2024/066854, filed on Jun. 17, 2024.

(30) Foreign Application Priority Data
Jun. 15, 2023 (DE) 10 2023 115 598.9

(51) Int. Cl. H02J 3/466; H02J 3/0014; H02J 3/175; H02J 3/38; H02J 101/20; H02J 103/35

(52) U.S. Cl. CPC H02J 3/466; H02J 3/0014; H02J 3/175; H02J 3/381; H02J 2101/20; H02J 2103/35

(57) ABSTRACT

The application relates to a method for operating an energy supply plant having a plurality of inverters and a plant controller which is in communicative connection with the inverters. The energy supply plant has a grid connection connected to an AC voltage grid. The inverters exchange electrical exchange power with the AC voltage grid via the grid connection, so that the energy supply plant exchanges a total exchange power with the AC voltage grid, which includes the respective electrical exchange powers. The plant controller determines individual inverter power setpoints depending on a plant setpoint for the total exchange power of the energy supply plant and transmits the individual inverter power setpoints to the controllers of the inverters. The respective inverter controllers set the respective exchange powers of the inverters depending on the inverter power setpoints. The inverter controllers are configured for gridforming, and the inverters provide instantaneous reserve power.

### REFERENCE TO RELATED APPLICATIONS

This application is a Continuation of International Application number PCT/EP2024/066854, filed on Jun. 17, 2024, which claims the benefit of German Application number 10 2023 115 598.9, filed on Jun. 15, 2023. The contents of the above-referenced Patent Applications are hereby incorporated by reference in their entirety.

### FIELD

The application relates to a method for operating an energy supply plant, as well as an energy supply plant and an inverter. The energy supply plant comprises a plurality of inverters and a plant controller. The plant controller is communicatively connected to the inverters. The inverters of the energy supply plant have a common grid connection via which they exchange electrical power with an AC voltage grid.

### BACKGROUND

Conventional energy supply plants, in particular thermally operated power plants and also hydroelectric power plants, comprise grid-synchronous rotating flywheel masses of synchronous generators or turbines and the respective drive train. Such energy supply plants exchange electrical power with an electrical AC voltage grid, wherein the entire flywheel mass of the plants is electromechanically effective, and in the grid, contributes significantly to the stabilization of the AC voltage grid. In particular, the inertia of the respective flywheel mass, due to the rotational energy stored therein, causes an inertia of the rotating voltage space vector of the conventional energy supply plants with respect to the voltage space vector in the AC voltage grid. As a result, in the event of phase jumps and/or frequency changes of the voltage space vector in the AC voltage grid, an instantaneous power change in the energy supply plants occurs, which is caused in particular by inductive effects and a phase angle difference between the voltage space vector of the flywheel and the voltage space vector of the grid voltage. In this respect, a conventional energy supply plant provides a so-called instantaneous reserve and limits the rate of change of the grid frequency of the AC voltage grid, in particular in the event that power imbalances between the supply and outflow of electrical power, i.e. between generation and consumption in the AC voltage grid, occur relatively briefly, for example, due to a fault in a transmission line in the AC voltage grid.

The energy exchanged as an instantaneous reserve power between the energy supply plant and the AC voltage grid is drawn from or supplied to the rotating mass of the conventional energy supply plants by decelerating or accelerating the respective flywheel mass, wherein the power exchanged and the energy exchanged are limited overall by the physical characteristics of the energy supply plant. The provision of the instantaneous reserve ends as soon as the voltage space vector of the flywheel mass has synchronized with the voltage space vector of the grid and its rotation frequency has matched to the grid frequency, i.e. in particular as soon as a drifting away of the grid frequency has stopped, for example, after the power equilibrium has been eliminated by further frequency retention mechanisms or a grid self-regulating effect.

In contrast, energy supply plants which exchange electrical power with the AC voltage grid via power-electronic power converters, such as photovoltaic plants, wind power plants or grid-connected energy storages, generally have no rotating masses and therefore no mechanical inertia, virtually no mechanical storage capability and no significant overcurrent capability. The electronic power converters of such energy supply plants, in particular inverters, may be configured to exchange a given electrical power with an existing AC voltage grid or can themselves set up a stand-alone grid.

From DE 10 2020 119 039 A1, a plant with inverters is known which operate with a respective droop controller to impress the voltage and can react “instantly” to grid events by changing the power. A plant controller adapts parameters of the droop controls. The adaptation includes, in particular, a change in the frequency setpoint or, alternatively, of the power setpoint in response to a power change in order to return the power of the plant to a setpoint grid power after a grid event. This solution makes it possible to precisely set the setpoint grid power at the grid connection.

EP 3 783 765 A1 discloses a P (df/dt) inertia emulation which can be implemented, for example, by superimposed controls. This also makes it possible to implement grid-following control concepts which can be stationary accurate at the grid connection, for example, if an integral component is used in the plant controller.

### SUMMARY

The application is directed to a method for operating an energy supply plant, as well as an energy supply plant, by means of which the exchange of electrical energy between the energy supply plant having a plurality of inverters and an AC voltage grid can be further improved. It is a further object to provide an inverter for use in such an energy supply plant.

An energy supply plant with a plurality of inverters and a plant controller that is in communicative connection with the inverters comprises a grid connection with which the inverters are connected and which is connected to an AC voltage grid. In a method for operating such an energy supply plant, the inverters exchange electrical exchange powers with the AC voltage grid via the grid connection so that the energy supply plant exchanges a total exchange power with the AC voltage grid, which comprises the respective electrical exchange powers of the inverters. The plant controller determines individual inverter power setpoints depending on a plant setpoint for the total exchange power of the energy supply plant. The plant controller transmits the individual inverter power setpoints to the inverter controllers. The respective inverter controllers set the respective exchange powers of the inverters depending on the inverter power setpoints. The method is characterized by the fact that the inverter controllers are configured for gridforming, and the inverters provide individually adjustable instantaneous reserve power.

The method according to the application enables operation of an energy supply plant in such a way that it provides, via its grid connection, on the one hand a total exchange power, and on the other hand an instantaneous reserve power, which are each composed of individually set contributions from the gridforming controlled inverters.

In one embodiment of the method, measured exchange powers of the respective inverters are transmitted to the plant controller. The plant controller continuously or periodically redeterimines the inverter power setpoints depending on the measured exchange powers and transmits them to the inverters. The controllers of the respective inverters then set their respective exchange powers depending on the respective reascertained inverter power setpoints.

An advantage of the method according to one embodiment is that the total exchange power at the grid connection can be set more precisely while simultaneously providing instantaneous reserve. For example, the contributions of the individual inverters to the total exchange power can be precisely set by the plant controller. In addition, all power contributions to the instantaneous reserve power can be set with high precision not only at the grid connection but also within the energy supply plant. For example, the total exchange power and the instantaneous reserve power at the grid connection can be individually distributed among the inverters within the energy supply plant, wherein the distribution to the inverters can be optimized, for example, with regard to the respective requirements of the energy sources, storage devices or consumers connected to the inverters. This therefore makes it possible to achieve a stationary precise distribution of power between individual inverters in the energy supply plant with highly dynamic instantaneous reserve power at the grid connection simultaneously.

The plant controller is, for example, a unit, e.g. a computing unit, a processor, or processing circuitry, for measuring, signal processing and controlling or regulating the energy supply plant as a whole. The plant controller controls, for example, the total exchange power at the grid connection.

In one embodiment, the electrical power controlled by the method and exchanged with the AC voltage grid can be pure active power or pure reactive power. Alternatively or additionally, the method can be used to control a power that represents a positive sequence power or a negative sequence power. In addition, the method can be used to control currents instead of powers. These can be active currents or reactive currents that are used in positive sequence system components and/or negative sequence system components when regulating.

In one embodiment of the method, the plant controller determines the individual inverter power setpoints by normalizing the plant setpoint to the respective relative nominal power of the respective inverter and adding an individual offset value, wherein the sum of the offset values results in the value zero. The normalization can be achieved, for example, by dividing the nominal power of the respective inverter by the sum of the nominal powers of the inverters in the energy supply plant. The individual offset makes it possible to take into account, for example, the individual conditions of a respective inverter, e.g. its age or its operating time, as well as individual conditions of the DC voltage sources or DC voltage sinks connected to the inverters, e.g. a current state of charge of a connected energy storage device, a utilization of a connected consumer, e.g. an electrolyzer or similar. The different power distribution between individual inverters of the energy supply plant can be used, for example, to balance the charge states and aging states of individual DC voltage sources connected to the inverters, e.g. batteries, or to control electrolyzers or other consumers of different power classes connected thereto. By setting the sum of the offset values to the value zero, it is possible for the inverters of the energy generation plant to contribute more or less to the desired total exchange power according to their individual circumstances. This allows the power contributions to be set even more precisely, while at the same time precisely setting the total exchange power.

In one embodiment of the method, the gridforming controllers (50.X) react autonomously to grid events with an individually settable power response. For this purpose, the gridforming controllers of the inverters each comprise a voltage-impressing droop control and an inertia-generating control which are linked together within the framework of the gridforming controller and together provide an instantaneous reserve power. The inverters set their respective exchange powers by means of a respective droop control with the aid of a droop characteristic depending on a droop characteristic reference power and on a respective voltage profile deviation of a voltage profile of a grid voltage from a respective reference profile based on a droop setpoint. Depending on the power quantity for which the controller is used, the droop setpoint can be, for example, a frequency setpoint or a voltage amplitude setpoint. In the event that the active power of the energy supply plant is controlled using the method, the droop control can specify an f(P) relationship between a respective exchange active power as a measure of the voltage profile deviation and a frequency or phase deviation relative to a frequency setpoint. If the method controls a reactive power of the energy supply plant, the droop controller specifies a U(Q) relationship between a respective exchange reactive power as a measure of the voltage profile deviation and a voltage deviation relative to a voltage amplitude setpoint. In the case of positive or negative sequence power control, the droop setpoint includes corresponding setpoints of the positive and negative sequence system components of the frequency or the phase angle and the voltage amplitude.

By means of such a droop control, the respective inverters can react to voltage profile deviations in the AC voltage grid and provide or draw more or less electrical power by synchronously and quickly adapting the frequency and amplitude of the voltage profile of the voltage provided at the grid side of the inverter. The occurrence of an initial voltage profile deviation of the voltage profile of the grid voltage from a reference voltage profile causes a deviation of the exchange active power of the inverter, when relating to the frequency setpoint, and a deviation of the exchange reactive power of the inverter, when relating to the setpoint voltage amplitude, from the respective droop characteristic reference power. The voltage profile deviation of the voltage profile is, for example, a phase angle difference between the phase angles of the inverter output voltage and of the grid voltage, which causes the deviation of the exchange active power via an output-side impedance, or an amplitude difference between an amplitude of the inverter output voltage and of the grid voltage, which causes the deviation of the reactive power. The exchange active power and the exchange reactive power therefore serve as a respective measure of the phase angle difference or the amplitude difference, respectively. In the case of active power control, the exchange active power is in turn converted according to the droop characteristic within the droop control into a proportional change of the frequency of the output voltage of the inverter. As a result, the droop control synchronizes the frequency of the output voltage to the grid frequency but maintains the resulting phase angle difference so that the exchange active power of the inverter deviates from the droop characteristic reference power by a value that is essentially proportional to the deviation of the grid frequency from the frequency setpoint. In one embodiment, the energy supply plant can thereby react to changes or jumps in the phase angle and/or in the frequency of the voltage space vector of the grid voltage with a targeted variation of the active power, or to changes in the amplitude of the grid voltage with a targeted variation of the reactive power, wherein the magnitude of the variation can be set by the gradient of the droop characteristic.

An advantage of the droop controller, in one embodiment, is therefore that the voltage profile of the output voltage of the respective inverter is synchronized to the voltage profile of the AC voltage grid with respect to frequency and amplitude in such a way that a provision of an instantaneous power response with regard to active power and/or reactive power at the grid connection point of the energy supply plant is made possible, which can be set via the droop characteristic and which is proportional to the deviation of the voltage profile of the output voltage from the specified frequency and voltage amplitude. The gridforming contribution of the droop control is provided by a deviation of the actual inverter power from the inverter power setpoint and lasts until the deviation of the output voltage profile from the specified frequency and voltage amplitude is eliminated, for example, by a higher-level controller and/or a return of the AC voltage of the AC voltage grid to a pre-fault state. This can make an important contribution to gridforming, e.g. in the form of highly dynamic grid services, for example, for frequency and voltage control. This makes possible a very fast, even instantaneous, response to grid events that directly support the grid, which, depending on the power and energy reserves within the energy supply plant, can make a significant contribution to grid support.

In one embodiment of the method, the inverters can, by means of an inertia-generating control, vary an input value of the droop control, for example, the droop characteristic reference power, depending on an individual power deviation of the respective inverter, in order to return the exchange power of the inverters to the respective inverter power setpoint if there is a deviation of the voltage profile of the output voltage from the voltage in the AC voltage grid and consequently a power reaction takes place due to the droop control. The individual power deviation of the respective inverter can correspond to a deviation of the measured individual exchange power from the inverter power setpoint specified by the plant controller. The dynamics of returning the exchange power of the inverters to the respective inverter power setpoint can be set in the inertia-generating control, for example, by means of an inertia constant which is multiplied with the (integrated) power deviation of the respective inverter when varying the droop characteristic reference power.

The advantage of the inertia-generating control is that the inertia of the resulting voltage space vector of the energy supply plant in the case of grid events can be set in such a way that the resulting power and energy exchange with the grid is proportional to the rate of change of the frequency or of the amplitude of the voltage profile of the grid voltage. Instantaneous reserve requirements can be met, and the energy supply plants operated with such method act in a gridforming manner according to their capabilities.

The individual power and energy reserves of the sources and/or sinks connected to the inverters, which are available for gridforming with this operating mode, can be optimally utilized via the settable inertia constants of the inertia-generating control. Due to the inertia-generating control, lower energy reserves are required for gridforming in comparison to pure droop control. In addition, the inertia-generating control makes it possible to set the individual exchange powers of the inverters and therefore also the total exchange power of the energy supply plant with high steady-state accuracy with respect to the plant setpoint, for example, even in the case of a steady-state deviation of the voltage profile of the output voltage from a voltage profile having nominal frequency and nominal voltage.

In embodiments of the method, the gridforming controllers of the inverters include a sign-dependent weighting of the deviation of the individual exchange power from the respective power setpoint. In one embodiment, the gridforming controllers can include an asymmetry static that weights the deviation of the individual exchange power from the respective power setpoint differently depending on the sign of the voltage profile deviation. Such an asymmetry static can in particular comprise an asymmetric characteristic which is used in the droop control and/or in the inertia-generating control of the inverters.

An asymmetry static can, for example, be used in the respective droop control to adjust the frequency of the output voltage of the inverter in the event of a voltage profile deviation due to a grid frequency gradient either slowly or quickly, depending on the sign of the grid frequency gradient, i.e. in which direction the grid frequency changes.

Specifically, the asymmetry static in the droop controller can be implemented as an asymmetric droop characteristic or droop asymmetry static which, for example, translates a positive deviation of the exchange active power due to a falling grid frequency into a comparatively small adjustment of the frequency of the output voltage of the inverter so that a comparatively large phase angle difference arises, and a correspondingly large amount of instantaneous reserve power is called up; conversely, a negative deviation of the exchange active power due to an increasing grid frequency can be translated into a comparatively large adjustment of the frequency of the output voltage of the inverter so that the phase angle difference remains comparatively small, and correspondingly little instantaneous reserve power is called up. Alternatively, the droop asymmetry static can be configured in exactly the opposite way, for example, to provide little instantaneous reserve power when the grid frequency decreases and a great deal of instantaneous reserve power when the grid frequency increases.

Alternatively or additionally, an asymmetry static can be used in the inertia-generating control to vary the droop characteristic reference power in case of an individual power deviation of the respective inverter quickly or slowly, depending on the sign of the power deviation. An individual power deviation can occur if the respective inverter power setpoint is changed by the plant controller and/or if there is a voltage profile deviation with a possible reaction thereto by the droop controller.

Specifically, the asymmetry static in the inertia-generating control can be realized as an asymmetric inertia constant or inertia asymmetry static. For example, a positive deviation of the exchange active power due to a decreasing grid frequency can be multiplied by a comparatively large inertia constant, so that the droop characteristic reference power varies comparatively strongly in a counteracting manner and correspondingly little instantaneous reserve power is called up; conversely, a negative deviation of the exchange active power due to an increasing grid frequency can be multiplied by a comparatively small inertia constant so that the droop characteristic reference power varies comparatively little in a counteracting manner, and correspondingly a great deal of instantaneous reserve power is called up. Alternatively, the inertia asymmetry static can be configured in the opposite way to provide a great seal of instantaneous reserve power when the grid frequency decreases and little instantaneous reserve power when the grid frequency increases.

Due to this sign dependence of the asymmetry static, it is possible to individually set which instantaneous reserve power an inverter provides for a given voltage profile deviation. In doing so, the direction in which the exchange power of the respective inverter changes due to the underlying grid event is at least indirectly taken into account, and this gridforming change in the exchange power is either permitted and, if necessary, amplified, or it is limited and, if necessary, suppressed.

The sign-dependent weighting of the deviation of the exchange power from a respective power setpoint in the grid-forming control, for example, expressed as a sign-dependent constant or gradient of a corresponding asymmetry static, can differ for the two signs of the voltage profile deviation, e.g. depending on the sign of a grid frequency gradient, by at least a factor of 2, in order to, for example, counteract a falling grid frequency, which indicates a critical power deficit in the AC grid, with a larger instantaneous reserve power than an increasing grid frequency, which indicates a possibly less critical power surplus in the AC grid. In one embodiment, the weighting differs depending on the sign by at least a factor of 5, in one embodiment by at least a factor of 10, for example, in order to set the provision of an asymmetric instantaneous reserve power which is generated largely exclusively for one sign of the voltage profile deviation and is absent as completely as possible in the case of an opposite voltage profile deviation.

In embodiments of the method, the asymmetry static can additionally depend on the grid frequency. The grid frequency can be measured, for example, in the AC voltage grid or approximated by the output frequency of the inverter. For example, by means of a case distinction, the asymmetry static can be configured such that an instantaneous reserve power due to a grid frequency gradient is only provided if the grid frequency deviates from a nominal frequency in the same direction as the grid frequency gradient, i.e. if, for example, an overfrequency is present and the grid frequency continues to rise. Conversely, an instantaneous reserve power which should be inherently provided based on the asymmetry static can be suppressed if the grid frequency gradient points in the direction of the nominal frequency, i.e. if, for example, an overfrequency is present, and an already falling grid frequency should not be unnecessarily counteracted.

Furthermore, the asymmetry static can additionally or alternatively be dependent on the respective exchange power. This provides a further degree of freedom for setting individually the instantaneous reserve power provided by the respective inverter, for example, by limiting the instantaneous reserve power to a maximum exchange power or only starting at a minimum exchange power.

The power control dynamics of the droop control is typically faster than the power control dynamics of the inertia-generating control so that the setting of the exchange power by the droop control in case of a voltage profile deviation is faster than the variation of the droop characteristic reference power by the inertia-generating control (53.X) in case of a deviation of the exchange power from the inverter power setpoint.

The energy supply plant with the method according to the application on the one hand responds quickly to changes in the power setpoint by means of the droop control and on the other hand reacts to grid events with a prespecifiable instantaneous reserve power by means of the inertia-generating control. In one embodiment, if a power deviation at the grid connection is caused by a reaction of the droop control to a voltage profile deviation, the setpoint tracking behavior and the disturbance response behavior of the energy supply plant can be decoupled from each other. Due to the synchronizing behavior of the droop control a faster synchronization with other voltage sources in the energy supply plant can be achieved, which results in fewer compensating oscillations and better damping. At the same time, the inertia-generating component ensures that the exchange power during grid events is comparable to the inertia of a rotating mass, i.e. proportional to the gradient of the frequency or of the voltage amplitude during the grid event, so that the exchange power is adjusted to the plant setpoint in accordance with an adjustable inertia dynamic. This behavior enables the energy supply plant to make an optimal contribution to grid stability and to energy supply.

A very fast setpoint tracking behavior can be realized at the grid connection, and at the same time the inertia of the voltage space vector can be maintained despite excitation by grid events and disturbances. This takes into account that the plant setpoint for the total exchange power is often a quasi-stationary value which itself should not react or react rather slowly to disturbances, and that, on the other hand, an instantaneous reserve of the energy supply plant should be provided as quickly as possible. The combination of the fast droop control and slower inertia-generating control makes it possible to parameterize the setpoint tracking behavior and the disturbance response behavior separately and, for example, to use separate feedforward controls for the respective output values.

In one embodiment of the method, the total exchange power of the energy supply plant is determined and, for example, in the plant controller, a total power deviation of the total exchange power from the sum of the measured exchange powers of the inverters is determined.

The total power deviation can be normalized to the respective relative nominal powers of the respective inverters, and the normalized partial power deviations determined in this way can be taken into account when determining the inverter power setpoints, e.g. in the plant controller.

In one embodiment of the method, the respective inertia-generating controls vary the droop characteristic reference power of the droop controller using a feedforward control with the product of an individual feedforward control value and a first correction factor. Alternatively or additionally, the respective droop controls determine the phase angle of the output voltage of the inverter using a feedforward control with the product of the individual feedforward value and a second correction factor. The individual feedforward control value can be formed, for example, by the inverter's individual fraction of the plant setpoint or by a weighted sum of the inverter's individual fraction of the plant setpoint and the individual inverter power setpoint, wherein the weighted sum is formed, for example, using two correction factors whose sum is equal to one.

In one embodiment of the method, the input value of the droop control, the droop characteristic reference power, is varied within the inertia-generating control as a function of the product of a first weighting factor and the individual deviation of the measured individual exchange power of the respective inverter from the inverter power setpoint of the respective inverter. Furthermore, the input value of the droop control, the droop characteristic reference power, can be varied as a function of the product of a second weighting factor and the inverter's individual fraction of the plant deviation. For this purpose, an input value of the inertia-generating control can be formed from a sum of the individual power deviation and the individual fraction of the plant deviation, weighted by the weighting factors. It may be provided that the sum of the first weighting factor and the second weighting factor results in the value one.

An energy supply plant with a plurality of inverters and with a plant controller that is in communicative connection with the inverters is configured to be operated using one of the methods described above. Here, the controllers of the inverters of the energy supply plant can each comprise an asymmetry static and be configured to provide an individually settable symmetrical or asymmetrical instantaneous reserve power, wherein the energy supply plant is configured to provide a settable symmetrical or asymmetrical instantaneous reserve power at the grid connection.

Furthermore, at least one inverter is disclosed which is designed for use in such an energy supply plant. The inverter comprises a gridforming controller which, in one embodiment, comprises a droop control and a superimposed inertia-generating control for changing an input value of the droop controller, for example, a droop characteristic reference power. The inverter is, in one embodiment, controlled to act as a voltage source and can, for example, include an asymmetry static and provide a settable symmetrical or asymmetrical instantaneous reserve power.

In alternative embodiments, the controllers can operate on currents instead of powers. These can be active currents or reactive currents that are used in positive sequence system components and/or negative sequence system components in the control. As a result, high current accuracy can be achieved at the grid connection.

The connection point of the energy supply plant to the AC voltage grid can alternatively be any other point in the AC voltage grid, e.g. a so-called point of stability, POS. The point of stability can be controlled, for example, by the energy supply plant described or by a plurality of energy supply plants.

With the described method, the need for additional instantaneous reserve can be met, for example, in regions with a high proportion of non-conventional, e.g. renewable, energy supply plants and/or with spatially extended grid structures comprising energy storage plants, photovoltaic plants and/or wind turbines. The method and the energy supply plant can, for example, provide instantaneous reserve power and primary control power within the framework of grid system services, which can be offered, for example, in a corresponding control power or balancing energy market. So-called grid boosters or statcoms are examples of commercially available gridforming grid resources. The provision of grid services at the grid connection of the energy supply plant is made possible and therefore extends beyond the control of individual inverters. The power supply, for example the inertia behavior in combination with other gridforming properties at the grid connection, can be provided with great precision and dynamics by the method according to the disclosure and the energy supply plant according to the disclosure. The utilization of available power reserves of the energy supply plant can be improved so that the energy supply plant can effectively contribute to supply security.

### BRIEF DESCRIPTION OF THE FIGURES

The disclosure is further explained and described below with reference to example embodiments illustrated in the figures.

FIG. 1 schematically shows a known method for operating an energy supply plant,

FIGS. 2-3 schematically show embodiments for operating an energy supply plant,

FIGS. 4-11 schematically show various concrete embodiments of the method according to the disclosure for operating an energy supply plant, and

FIGS. 12-24 show time graphs of various electrical variables resulting from an excitation by an example grid event when the method according to the application is used with different parameters.

In the figures, identical or similar elements are denoted by the same reference signs. The figures are not to scale, and elements of individual figures may also be used analogously in other figures.

### DETAILED DESCRIPTION

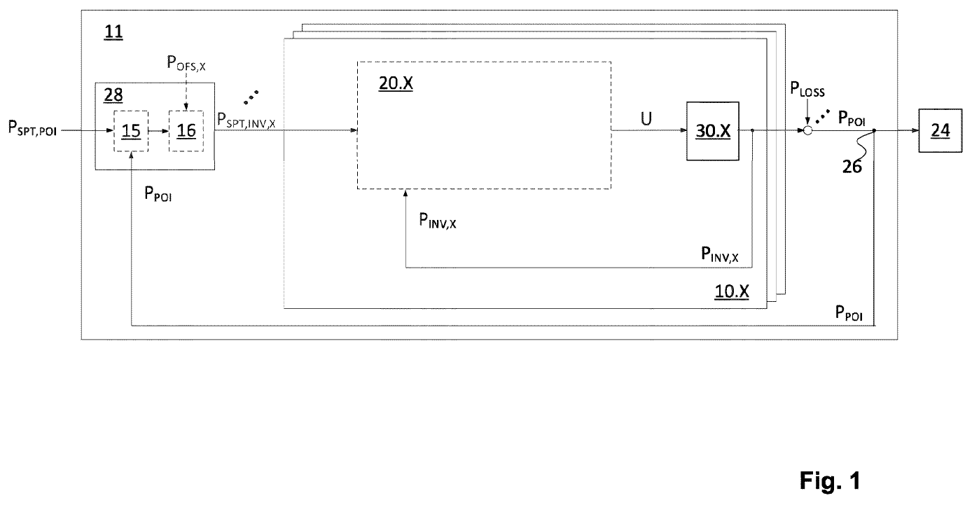

FIG. 1 schematically shows a known method for operating an energy supply plant 11 with a plurality of inverters 10.X. The energy supply plant 11 can comprise a plurality of generators, storage devices and/or consumers, for example, photovoltaic generators, battery storage devices and/or electrolyzers, which exchange, i.e. receive and/or deliver, electrical power via respective inverters 10.X. Via a grid connection 26 the energy supply plant 11 exchanges total electrical exchange power P_{POI} with an AC voltage grid 24. The total exchange power P_{POI} essentially includes the individual exchange powers P_{INV,X}, which are generated by the 10.X inverters depending on individual inverter power setpoints P_{SPT,INV,X}, and any power loss P_{Loss} which, for example, drops in connecting lines between the inverters 10.X and the grid connection 26. The individual inverter power setpoints P_{SPT,INV,X} are specified by a plant controller 28 and transmitted to the inverters 10.X.

An inverter 10.X has a controller 20.X. A voltage profile U is an output value of the controller 20.X of the inverter 10.X. The voltage profile U calculated in the controller 20.X is set using a converter 30.X at the output of the inverter 10.X, for example, by suitable clocking of a suitable inverter bridge circuit of the inverter 10.X. At the output of the inverter 10.X, the individual exchange power P_{INV,X} of the inverter 10.X results as a function of the difference between the voltage profile U and the grid voltage profile. The sum of the individual exchange powers P_{INV,X} of the inverters 10.X minus the power loss P_{LOSS} yields the total exchange power P_{POI} of the energy supply plant 11 at the grid connection 26.

The controller 20.X receives as input values an inverter power setpoint P_{SPT,INV,X} from the plant controller 28 and the measured individual exchange power P_{INV,X} of the inverter 10.X.

The plant controller 28 receives as an input value a plant setpoint P_{SPT,POI} and the measured total exchange power P_{POI} and comprises a controller 15, for example, a proportional or integral controller. The controller 15 compares the plant setpoint P_{SPT,POI} and the measured total exchange power P_{POI} and modifies the plant setpoint P_{SPT,POI} depending on any deviations therebetween. Furthermore, the plant controller 28 comprises a dispatcher 16 which dispatches the plant setpoint P_{SPT,POI}, which may have been readjusted by the controller 15, to the individual inverter power setpoints P_{SPT,INV,X}. The dispatcher 16 can be parametrized with plant-specific properties, e.g. the relative nominal powers of the inverters 10.X, and with other parameters, e.g. individual offset values P_{OFS,X}, for dispatching the plant setpoint P_{SPT,POI} to the individual inverter power setpoints P_{SPT,INV,X}.

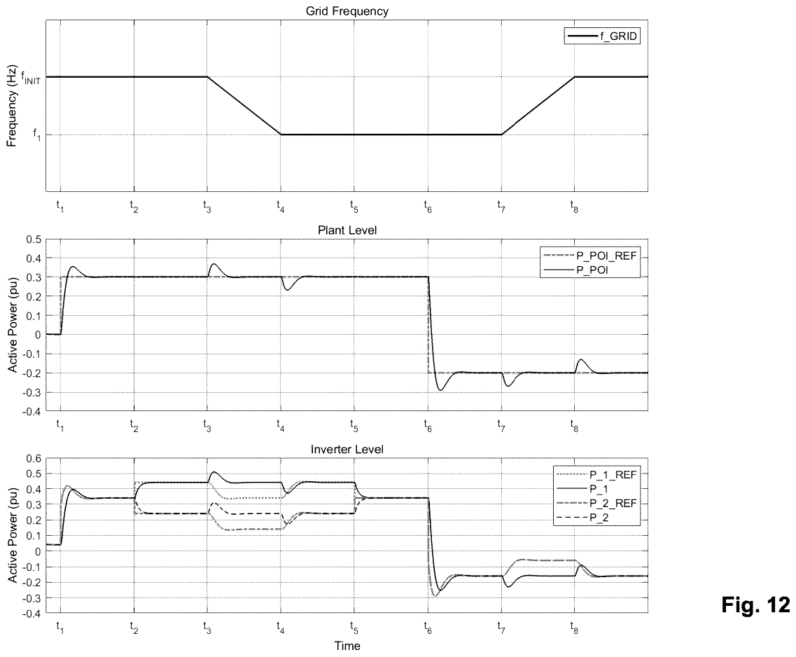

FIG. 12 shows by way of example a time profile of the setpoint and actual values of the energy supply plant 11 and of the inverters 10.1, 10.2 during use of a method according to FIG. 1.

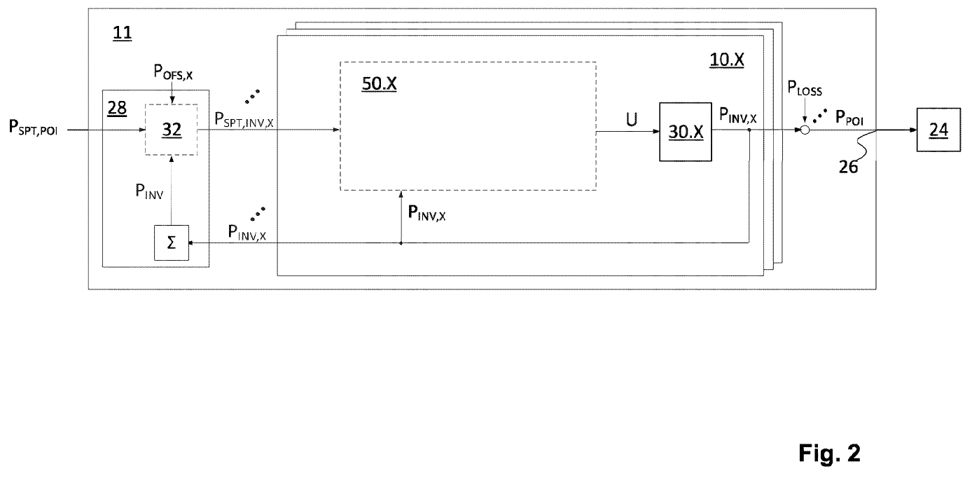

FIG. 2 schematically shows a method according to the disclosure for operating an energy supply plant 11. In contrast to the method according to FIG. 1, the feedback of the measured total exchange power P_{POI} via the controller 15 is omitted, and the inverter 10.X has a gridforming controller 50.X. The plant controller 28 has a dispatcher 32 which receives as input values the plant setpoint P_{SPT,POI} and the sum of the measured exchange powers P_{INV,X} of the inverters 10.X. The dispatcher 32 calculates the individual inverter power setpoints P_{SPT,INV,X} from these input values.

In contrast to the method according to FIG. 1, the total exchange power P_{POI} is no longer adjusted by minimizing its deviation from the plant setpoint P_{SPT,POI} using a controller 15, but rather by taking into account the sum of the dispatching exchange powers P_{INV,X} when distributing the given plant setpoint P_{SPT,POI} to the individual inverter power setpoints P_{SPT,INV,X} by the dispatcher 32. As a result, it can be achieved that the sum of the exchange powers P_{INV,X} corresponds to the plant setpoint P_{SPT,POI}. However, any power loss P_{Loss}, is not taken into account in the energy supply plant 11 and a corresponding deviation between the setpoint and actual value results at the grid connection 26.

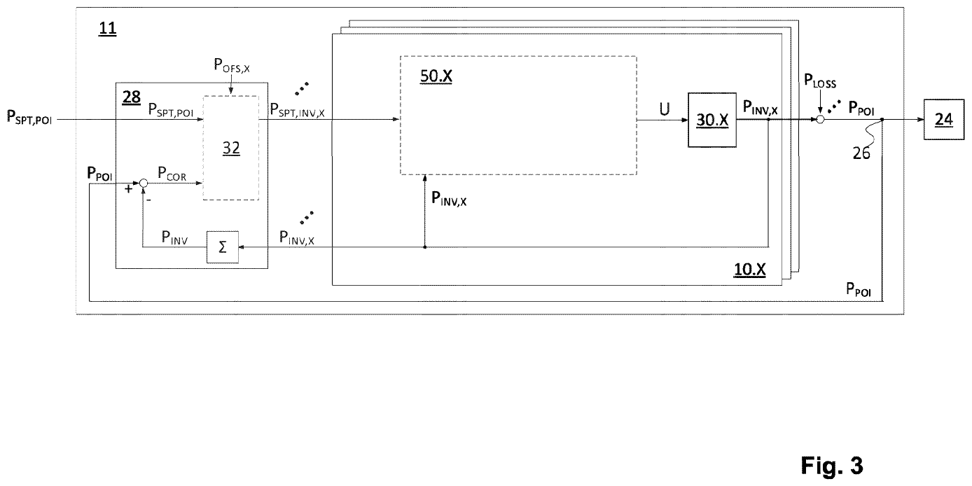

FIG. 3 schematically shows an embodiment of the method according to the disclosure for operating the energy supply plant 11. When calculating the individual inverter power setpoints P_{SPT,INV,X} the dispatcher 32 additionally takes into account a total power deviation P_{COR} which corresponds to the difference between the measured total exchange power P_{POI} and the sum of the measured exchange powers P_{INV,X} of the inverters 10.X. In contrast to the method according to FIG. 1, the total exchange power P_{POI} is therefore not adjusted but rather controlled in that the total power deviation P_{COR} is taken into account in the distribution of the given plant setpoint P_{SPT,POI} to the individual inverter power setpoints P_{SPT,INV,X} by the dispatcher 32.

By using the total power deviation P_{COR} in the dispatcher 32, for example, the power loss P_{Loss} is better taken into account so that the steady-state accuracy of the controller is improved. In addition, even the influences of any other, essentially unknown participants in the energy supply plant 11 are automatically taken into account so that their power contributions, which may eventually fluctuate as well, have no influence on the steady-state accuracy of the energy supply plant 11.

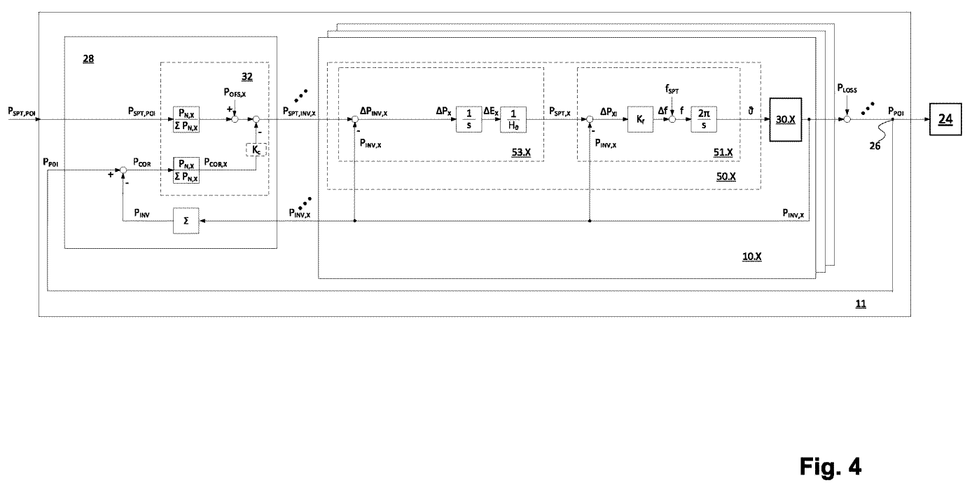

The following FIGS. 4 to 11 schematically show various concrete embodiments of the method according to the disclosure for operating the energy supply plant 11. Compared to FIGS. 1 to 3, the gridforming controller 50.X with a droop control 51.X and an inertia-generating control 53.X as well as the plant controller 28 are described in more detail. For example, the droop control 51.X is designed as an active power controller and specifically uses a frequency setpoint f_{SPT} as a droop setpoint so that the active power of the energy generation plant 11 at the grid connection 26 is specifically set by the embodiments shown in FIGS. 4 to 11. In this respect, the reference sign P in FIGS. 4 to 11 specifically designates an active power, and the further characteristic features of these methods are related to this active power. However, it is equally possible and covered by the subject-matter of this disclosure to relate the characteristic features of the method and the reference sign P as well as the associated quantities analogously to a reactive power or a positive- or negative-sequence system variable of a power or a current and to the respective variables complementary thereto.

FIG. 4 schematically shows a concrete embodiment of the method according to the disclosure for operating the energy supply plant 11. The gridforming controller 50.X includes a droop control 51.X and an inertia-generating control 53.X.

The inertia-generating control 53.X of the inverter 10.X receives as input values an inverter power setpoint P_{SPT,INV,X} from the plant controller 28 and the measured individual exchange power P_{INV,X} of the inverter 10.X, and determines therefrom a droop characteristic reference power P_{SPT,X}.

The droop control 51.X receives as an input value the droop characteristic reference power P_{SPT,X} from the inertia-generating control 53.X of the inverter 10.X. From the droop characteristic reference power P_{SPT,X} and a measured individual exchange power P_{INV,X} of the inverter 10.X, an individual droop inverter deviation ΔP_{Xi} of the inverter 10.X is determined. Using a droop characteristic, here specifically using the frequency constant K_{f}, a frequency shift Δf is determined therefrom. The frequency shift Δf is added to the frequency setpoint f_{SPT} of the AC voltage grid 24. The resulting frequency f is converted into a phase angle 9 and output as a voltage profile ϑ to the converter 30.X.

The inertia-generating control 53.X of the inverter 10.X receives an inverter power setpoint P_{SPT,INV,X} as an input value. An individual power control deviation ΔP_{INV,X} of the inverter 10.X is determined from the inverter power setpoint P_{SPT,INV,X} and a measured individual exchange power P_{INV,X} of the inverter 10.X. This is used as an individual deviation ΔP_{X} in the inertia-generating control in order to generate the droop characteristic reference power P_{SPT,X} as an output value by using an integrator 1/s and an inertia factor 1/H_{ϑ}. This droop characteristic reference power P_{SPT,X} serves as an input value for the droop control 51.X.

The other inverters 10.X of the energy supply plant 11 can be configured in the same way as described above. The controller 50.X shown in FIG. 4 is designed to be gridforming in that, on the one hand, the droop control 51.X immediately reacts to arising phase differences between the voltage profile ϑ at the inverter 10.X and the grid voltage and therefore to associated changes in the output power P_{INV,X}, and, on the other hand, by means of the inertia-generating controller 53.X in the steady state the inverter power setpoint P_{SPT,INV,X} is reached. In principle, inverters 10.X with such a controller 50.X according to FIGS. 4 to 11 (see below) can be combined with a plant controller 28 according to FIG. 2 or FIG. 3.

The plant controller 28 according to FIG. 4 comprises a dispatcher 32. As an input value, the plant controller 28 receives a plant setpoint P_{SPT,POI} for the total exchange power P_{POI} of the energy supply plant 11. From the plant setpoint P_{SPT,POI} and the respective relative nominal powers of the inverters 10.X, the dispatcher 32 determines the respective inverter power setpoints P_{SPT,INV,X}, wherein the respective relative nominal powers of the inverters 10.X correspond to the respective quotient of the respective nominal power P_{N,X} of an inverter 10.X and the sum of the rated powers P_{N,X} of the inverters 10.X in the energy supply plant 11. An individual offset value P_{OFS,X} for a respective inverter 10.X is added to its fraction of the plant setpoint P_{SPT,POI} normalized with the respective relative nominal power. Preferably, the sum of the offset values P_{OFS,X} yields the value zero.

It is possible to correct the power of each inverter 10.X within the plant 11. For this purpose, the plant controller 28 receives the measured exchange power P_{INV,X} of the inverters 10.X and determines the total power deviation P_{COR} between the total exchange power P_{POI} at the grid connection 26 and the sum P_{INV} of the measured exchange powers P_{INV,X} of the inverters 10.X in the plant 11. The total power deviation P_{COR} is normalized to the relative nominal power of the respective inverter 10.X and, at the output of the dispatcher 32, added to the inverter's 10.x normalized and possibly offset-modified fraction of the plant setpoint P_{SPT,POI}. As an output value, the plant controller 28 accordingly generates the respective inverter power setpoints P_{SPT,INV,X}.

The example embodiment illustrated makes it possible to realize a gridforming instantaneous reserve power at the level of the energy supply plant 11, also called plant-level inertia, in that the inverters 10.X each provide an individually settable instantaneous reserve power. At the same time, the total exchange power P_{POI} is spread to the inverters 10.X, taking into account a power dispatching, and is thereby set to the plant setpoint P_{SPT,POI} with high steady-state accuracy. The following information is exchanged between the plant controller 28 and the respective inverter 10.X:

The plant controller 28 transmits the individual inverter power setpoint P_{SPT,INV,X} for each inverter 10.X to the respective inverter 10.X. This is useful for power dispatching within the plant 11.

The measured individual exchange powers P_{INV,X} of the inverters 10.X in the plant 11 are transmitted by the inverters 10.X to the plant controller 28. This is useful for correcting the influence of power loss P_{Loss} on the steady-state accuracy of controlling the total exchange power P_{POI}.

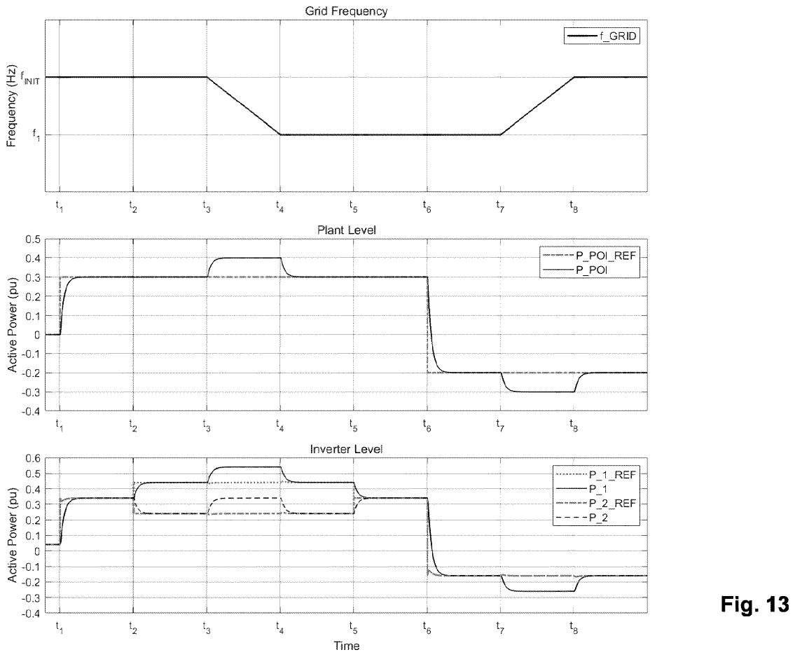

FIGS. 13 to 15 show by way of example time profiles of the setpoint and actual values for an energy supply plant 11 and its inverters 10.1, 10.2 when a method according to FIG. 4 is used.

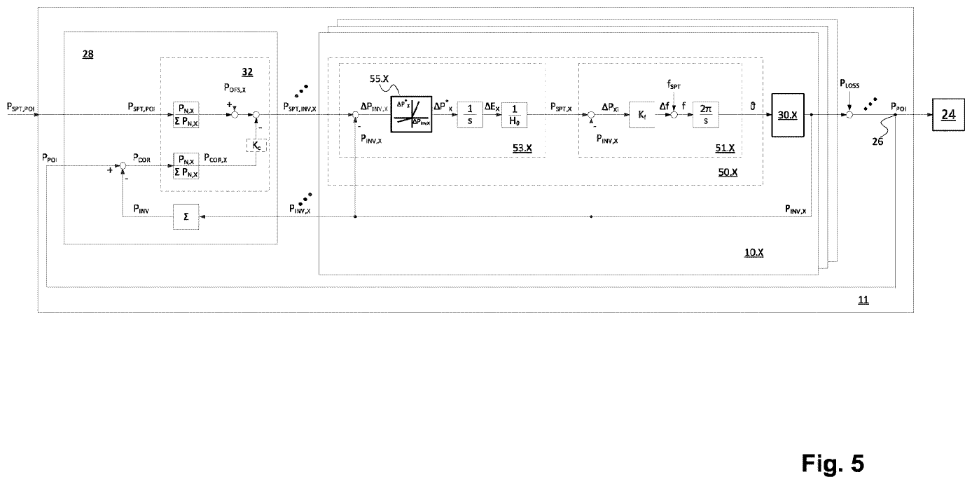

FIG. 5 schematically shows an embodiment of the method according to the disclosure, in which the energy generation plant 11 can provide an asymmetric instantaneous reserve power. In addition to FIG. 4, the inertia-generating control 53.X in FIG. 5 has an inertia asymmetry static 55.X which is applied to the individual power control deviation ΔP_{INV,X} to calculate the individual deviation ΔP_{X} from which the droop characteristic reference power P_{SPT,X} is subsequently generated as an initial value using the integrator 1/s and the inertia factor 1/H_{ϑ}. Alternatively, the inertia factor 1/H_{ϑ} can already be integrated in the inertia asymmetry static 55.X, wherein the inertia asymmetry static 55.X can also be realized as a case distinction with two different inertia factors 1/H_{ϑ}.

The inertia asymmetry static 55.X in the example according to FIG. 5 has a comparatively small gradient for negative values and a comparatively high gradient for positive values of the individual power control deviation ΔP_{INV,X}. This means that a negative individual power control deviation ΔP_{INV,X} is assigned a significantly smaller individual deviation ΔP_{X} than a positive individual power control deviation ΔP_{INV,X} of the same amount. In alternative embodiments, the ratios of the gradients of the positive and negative halves of the inertia asymmetry static 55.X can be set exactly inversely if required.

The dynamics of the resulting droop characteristic reference power P_{SPT,X}, which is used as an input value for the droop control 51.X, therefore depends, via the inertia asymmetry static 55.X, on the direction in which the exchange power P_{INV,X} deviates from the respective inverter power setpoint P_{SPT,INV,X}. Via the sign-dependent slope of the inertia asymmetry static 55.X it can individually set which inertia the instantaneous reserve power of the inverter 10.X comprises for a given voltage profile deviation with a given positive or negative sign and a related individual power control deviation ΔP_{INV,X}.

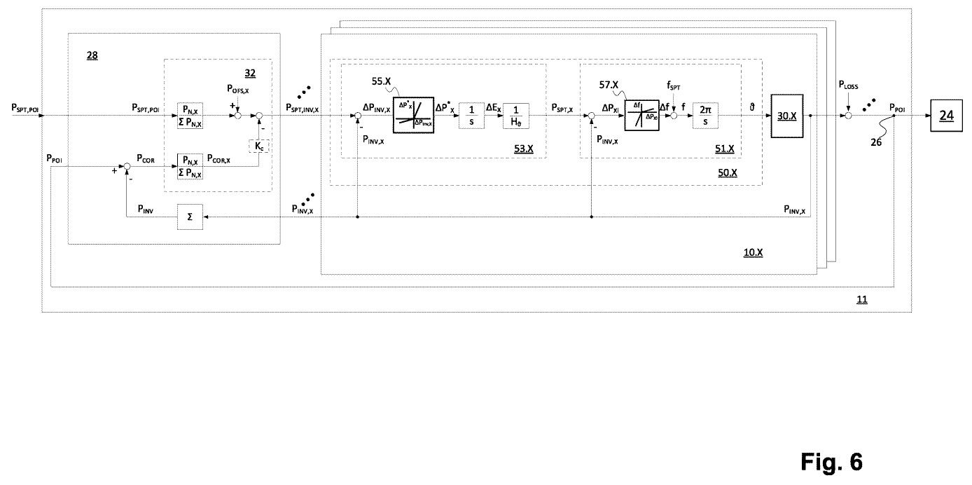

FIG. 6 schematically shows a further embodiment of the method according to the disclosure in which the droop control 51.X, in addition or as an alternative to FIG. 5 comprises a droop asymmetry static 57.X. The droop asymmetry static 57.X can replace the frequency constant K_{f} (see FIG. 4) or alternatively be configured as dimensionless and multiplied by the frequency constant K_{f}, eventually within the framework of a corresponding sign-dependent case distinction. The droop asymmetry static 57.X is applied to the individual droop inverter deviation ΔP_{Xi} and results in the frequency shift Δf which ultimately determines the voltage profile ϑ.

The droop asymmetry static 57.X in the example according to FIG. 6 has a comparatively small gradient for positive values and a comparatively high gradient for negative values of the individual droop inverter deviation ΔP_{Xi}. This means that a positive individual droop inverter deviation ΔP_{Xi} is assigned a significantly smaller frequency shift Δf than is a negative individual droop inverter deviation of the same magnitude ΔP_{Xi}. In alternative embodiments, the ratios of the gradients of the positive and negative halves of the droop asymmetry static 57.X can be set exactly inversely if required.

The dynamics of the resulting voltage profile ϑ, which is set by the converter 30.X at the output of the inverter 10.X, therefore depends, via the droop asymmetry static 57.X, on the direction in which the exchange power P_{INV,X} deviates from the respective droop characteristic reference power P_{SPT,X}. The sign-dependent gradient of the droop asymmetry static 57.X can be used to individually set the contribution of the droop control 51.X to the instantaneous reserve power of the inverter 10.X for a given voltage profile deviation with a given positive or negative sign and a related individual power control deviation ΔP_{INV,X}.

In summary, by means of an asymmetry static according to FIG. 5 or FIG. 6, in particular with the inertia asymmetry static 55.X and/or the droop asymmetry static 57.X, a different weighting of the deviation of the exchange powers P_{INV,X} from the respective inverter power setpoint P_{SPT,INV,X} is applied depending on the sign of the voltage profile deviation, for example depending on the sign of a grid frequency gradient. The weighting can differ by at least a factor of 2, preferably by a factor of 5. In one embodiment, the weighting, for example expressed as the amount of an inertia or frequency constant or as the gradient of the asymmetry static, can be different by at least a factor of 10, so that the provision of an asymmetric instantaneous reserve power can be set in particular such that an instantaneous reserve power is generated largely exclusively for one sign of the voltage profile deviation and is significantly reduced or even completely absent at a voltage profile deviation having the opposite sign.

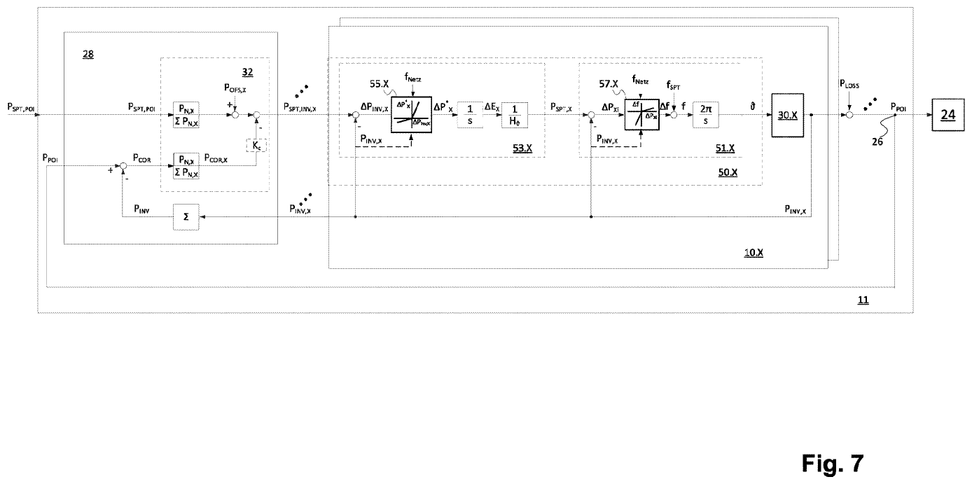

FIG. 7 shows an embodiment of the method according to the application, in which the asymmetry statics 55.X and/or 57.X are additionally dependent on the grid frequency f_{Netz} and optionally on the exchange power P_{INV,X} of the inverter 10.X. Depending on the current grid frequency f_{Netz}, for example, an instantaneous reserve power is only provided due to a grid frequency gradient and the resulting individual power control deviation ΔP_{INV,X} or droop inverter deviation ΔP_{Xi}, if the grid frequency f_{Netz} deviates from a nominal frequency in the same direction as the grid frequency gradient, e.g. if there is an overfrequency and the grid frequency f_{Netz} continues to rise. Conversely, an instantaneous reserve power which in principle should be provided based on the asymmetry static can be suppressed if the grid frequency gradient points in the direction of the nominal frequency, i.e. if, for example, an overfrequency is present and an already falling grid frequency should not be unnecessarily counteracted. The optional dependence of the asymmetry static 55.X and/or 57.X on the exchange power P_{INV,X} of the inverter 10.X can be used as a further degree of freedom, for example to define a power limitation and/or a dead band for the instantaneous reserve power, so that the instantaneous reserve power can be limited to a maximum exchange power or starts only after a minimum exchange power is reached.

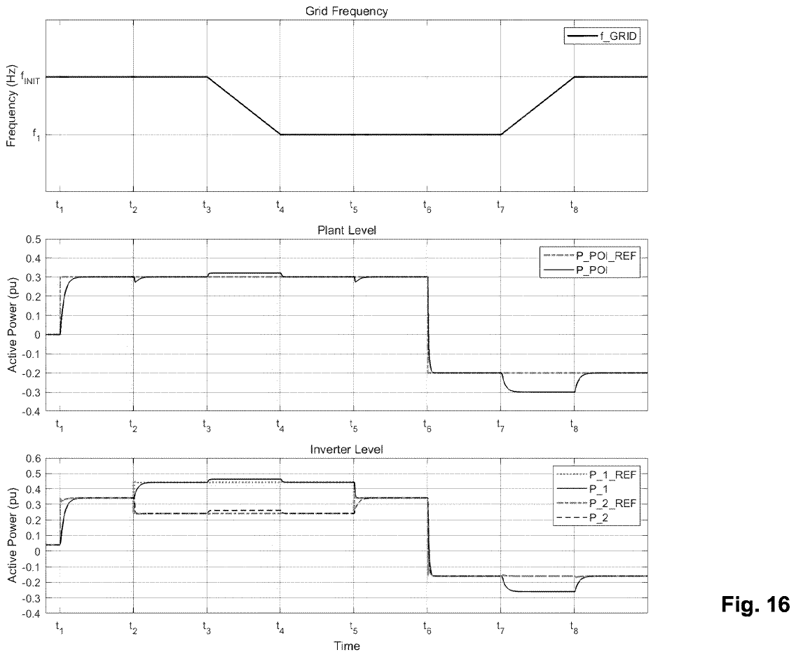

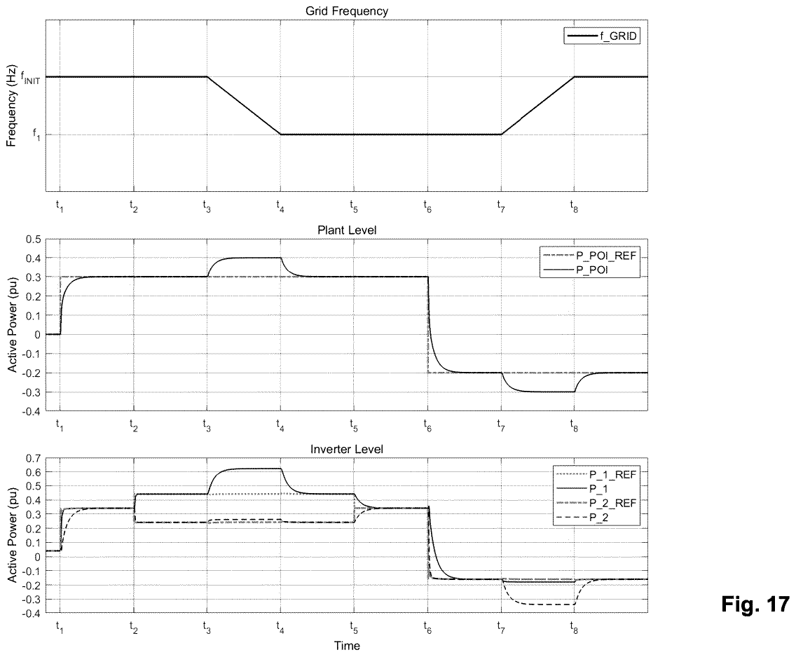

FIGS. 16 and 17 show by way of example time profiles of the setpoint and of actual values for an energy supply plant 11 and its inverters 10.1, 10.2 when a method according to one of FIGS. 5 to 7 with differently parameterized asymmetry statics 55.X, 57.X is used.

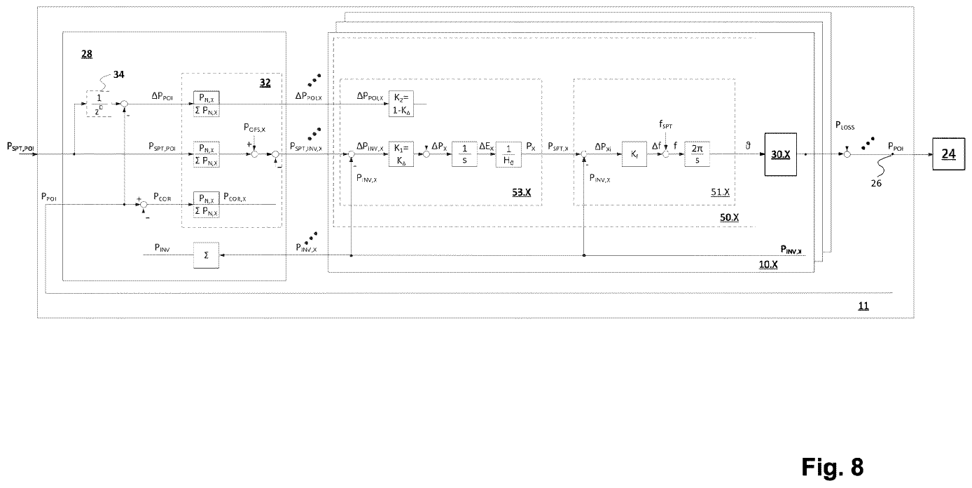

FIG. 8 schematically shows a further concrete embodiment of the method according to the disclosure. Deviating from FIGS. 4-7, in the inertia-generating control 53.X, the individual power control deviation ΔP_{INV,X} is corrected by a settable portion of the individual deviation fraction ΔP_{POI,X} of the plant deviation ΔP_{POI}. The individual deviation fraction ΔP_{POI,X} of the plant deviation ΔP_{POI} results from the power control deviation ΔP_{POI} at the plant connection point 26 and an individual normalization to the relative nominal power of the respective inverter 10.X.

In the gridforming controller 50.X, the individual power control deviation ΔP_{INV,X}, which was previously used exclusively in the inertia-generating control 53.X, is now weighted with a first weighting factor K₁. The individual deviation fraction ΔP_{POI,X} of the plant deviation ΔP_{POI,X} is weighted with a second weighting factor K₂. These weighted components are summed and optionally multiplied in the inertia-generating controller 53.X by an inertia asymmetry static 55.X and used as an individual deviation ΔP_{X} to generate the droop characteristic reference power P_{SPT,X} as an output value via an integrator 1/s and an inertia factor 1/H_{ϑ}. The sum of the weighting factors K₁ and K₂, with which the two control deviations are weighted, results in 1.

It is therefore possible to weight the power control deviation ΔP_{INV,X} at the inverter 10.X less heavily than the power control deviation ΔP_{POI,X} at the plant connection point 26 since the former path may have a greater delay. This then results in a higher weighting of the normalized power control deviation ΔP_{POI,X} at the plant connection point 26:

$${K}_{1} = {K}_{Δ} < {K}_{2} = 1 - {K}_{Δ}$$

The normalized individual deviation component ΔP_{POI,X} of the plant deviation ΔP_{POI} of the power P_{POI} at the grid connection 26 relative to the plant setpoint P_{SPT,POI}, which is scaled to the inverter 10.X, is send from the plant controller 28 to the respective inverter 10.X, weighted relative to the individual power control deviation ΔP_{INV,X} via the second weighting factor K₂, and used in the inertia-generating control 53.X to calculate the droop characteristic reference power P_{SPT,X}. This is for inertia precision at the grid connection 26.

The transmission of this information can be useful when there are communication delays in the transmission of the individual exchange powers P_{INV,X} of the inverters 10.X in the plant 11 to the plant controller 18. This can improve the dynamics of dispatching.

Alternatively or additionally, the individual deviation fraction ΔP_{POI,X} of the plant deviation ΔP_{POI} of the power P_{POI} at the grid connection point 26 can also be formed in the inverter 10.X, if the signals necessary for this, for example, the plant deviation ΔP_{POI}, are transferred to the inverter 10.X.

The individual deviation ΔP_{X} of an inverter 10.X in the plant 11, which is consequently fed to the inertia integrator of the inertia-generating control 53.X of the inverter 10.X, can be calculated as follows:

$$Δ {P}_{X} = {K}_{1} \cdot ( {P}_{SPT , INV , X} - {P}_{INV , X} ) + {K}_{2} \cdot ( {P}_{SPT , POI , X} - {P}_{POI , X} )$$

$${K}_{1} + {K}_{2} = 1 \to {K}_{1} = {K}_{Δ} , {K}_{2} = 1 - {K}_{Δ}$$

$$Δ {P}_{X} = {K}_{Δ} \cdot ( {P}_{SPT , INV , X} - {P}_{INV , X} ) + ( 1 - {K}_{Δ} ) \cdot ( {P}_{SPT , POI , X} - {P}_{POI , X} )$$

$$Δ {P}_{X} = {K}_{Δ} \cdot ( {\underbrace{\begin{matrix}( ( {P}_{SPT , POI} \cdot \frac{{P}_{NORM , X}}{{\sum }_{X} {P}_{NORM , X}} + {P}_{OFS , X} ) - \\ ( {P}_{POI} - {\sum }_{X = 1 ... N} ( {P}_{INV , X} ) ) \cdot \frac{{P}_{NORM , X}}{{\sum }_{X} {P}_{NORM , X}} )\end{matrix}}}_{{P}_{SPT , INV , X}} - {P}_{INV , X} ) + ( 1 - {K}_{Δ} ) \cdot ( {P}_{SPT , POI} - {P}_{POI} ) \cdot \frac{{P}_{NORM , X}}{{\sum }_{X} {P}_{NORM , X}}$$

Typically, K₁=K_{Δ}>0, K₂=1−K_{Δ}<1.

This allows the provision of an instantaneous reserve, also called plant-level inertia, and at the same time a precise control of the inverter 10.X with the described power allocation in the dispatcher 32 of the plant controller 28, as well as a precise control of the total exchange power P_{POI} at the grid connection 26.

FIG. 8 also shows the optional delay element 34. This enables that when the plant deviation ΔP_{POI} is formed, the plant setpoint P_{SPT,POI} is delayed by D sampling steps compared to the feedback of the total exchange power P_{POI}. This allows the dynamics of the setpoint tracking behavior of the overall exchange power P_{POI} at the grid connection 26 to be improved.

The number of sampling steps D and therefore the delay time can be set depending on the communication delays of data transmission and signal processing between plant controller 28 and inverter 10.X and on the dead times of the measured value acquisition of the total exchange power P_{POI}. A rate limiter of a feedforward control (see FIG. 7) can also have an influence on the choice of the sampling steps D. The slower the feedforward control, the greater the number of sampling steps D should be.

This makes satisfactory operation possible despite delays in the transmission of required data between the 10.X inverter and plant controller 28. The tendency to oscillate is kept low, and the adjustment speed is improved.

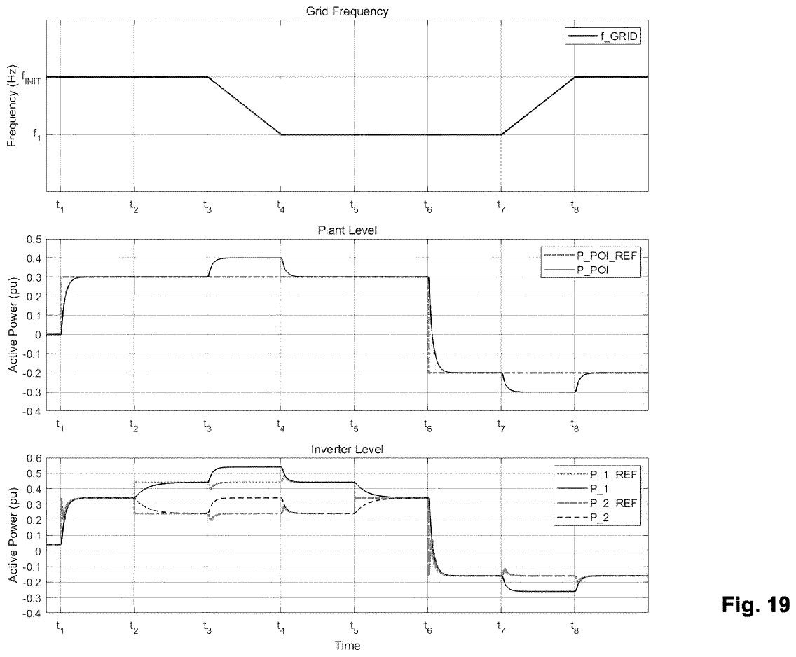

FIG. 19 shows by way of example time profiles of the setpoint and actual values for an energy supply plant 11 and its inverters 10.1, 10.2 when the method according to FIG. 8 is used. Overall, the embodiment of the energy supply plant 11 according to FIG. 8 has a reduced tendency to oscillate, wherein dead times during data transmission are taken into account, and the synchronicity of different data channels is improved.

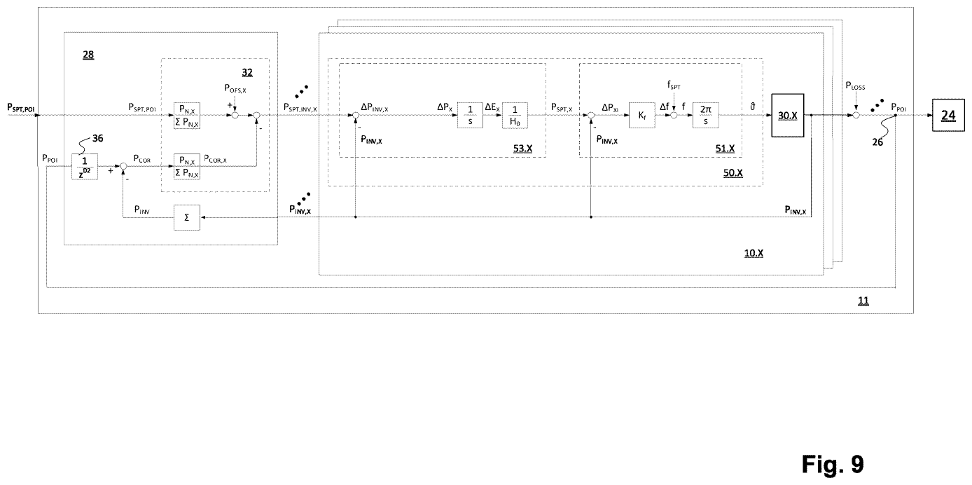

FIG. 9 schematically shows an embodiment of the energy supply plant 11 with improved synchronicity. By the introduction of a delay element 36 with the delay constant D2 in the plant controller 28, the feedback of the total exchange power P_{POI} of the plant is delayed and therefore better synchronized with the feedback of the measured exchange powers P_{INV,X} of the inverters 10.X. This can counteract oscillations. This delay element 36 can also be combined with other exemplary embodiments of this application.

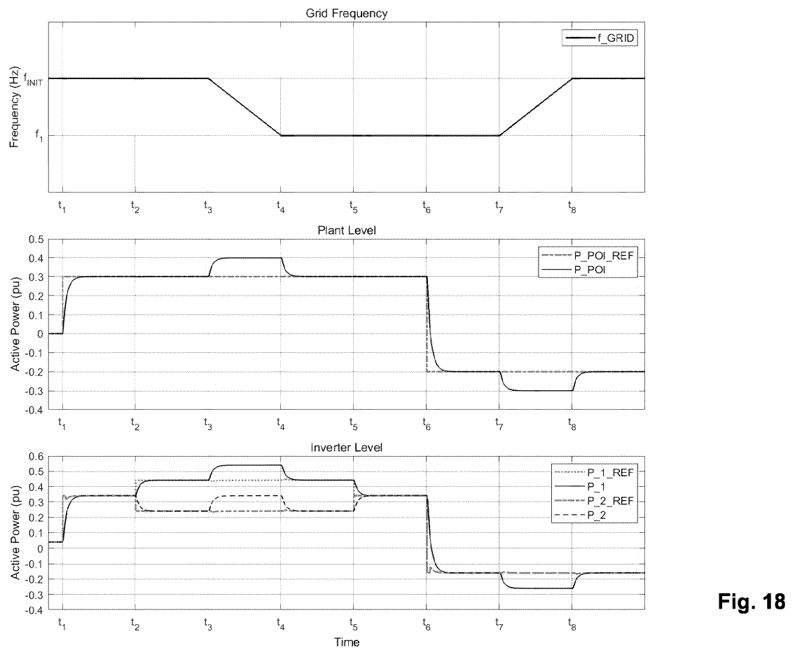

By delaying the feedback of the total exchange power P_{POI} by D2 sampling steps using the delay element 36, the feedback of the total exchange power P_{POI} can be synchronized with the sum of the measured individual exchange powers P_{INV,X} of the inverters 10.X, which are transmitted to the plant controller 28 with a delay as well, in particular due to communication latencies. This can be used to calculate meaningful individual correction values P_{COR,X}. This can improve the synchronicity between the inverter-side and the plant-side measurements. This can reduce the tendency to oscillate during transient events and improve the determination of the power loss P_{LOSS} for the precise setting of the total exchange power P_{POI}. FIG. 18 shows by way of example time profiles of the setpoint and actual values for an energy supply plant 11 and its inverters 10.1, 10.2 when the method according to FIG. 9 is used.

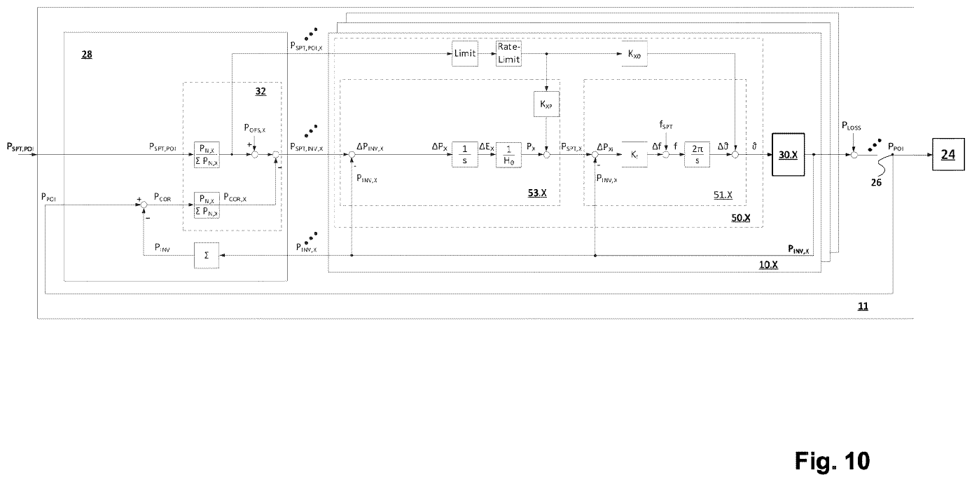

FIG. 10 schematically shows an embodiment of the energy supply plant with feedforward control to improve the setpoint tracking behavior of the energy supply plant 10. The illustrated embodiment with double feedforward control, which the plant controller 28 can use to intervene with settable weighting in the respective inertia-generating control 53.X and also in the respective droop control 51.X, makes it possible to realize fast setpoint tracking behavior for the total exchange power P_{POI} at the grid connection 26 and at the same time inertia with regard to the disturbance response behavior in the event of voltage profile deviations in the grid 24.

Via the upper path shown in FIG. 10, a feedforward control of the plant setpoint P_{SPT,POI}, in the form P_{SPT,POI,X} normalized to the inverter 10.X, can act on the set voltage angle ϑ and on the set droop characteristic reference power P_{SPT,X}, or alternatively on the frequency setpoint f_{SPT} of the grid voltage in the respective inverter 10.X. The so called individual fraction P_{SPT,POI,X} of the plant setpoint P_{SPT,POI}, i.e. the plant setpoint P_{SPT,POI} as normalized to the 10.X inverter, is used here as a feedforward value. The droop control 51.X converts the droop characteristic reference power P_{SPT,X} into a corresponding phase angle ϑ.

Via the feedforward control value and a first correction factor K_{XP}, the droop characteristic reference power P_{SPT,X} of the droop control 51.X is quickly adapted to a changed plant setpoint P_{SPT,POI}, i.e. to a new load situation, so that the slow inertia integrator of the inertia-generating control 53.X does not have to slowly readjust the droop characteristic reference power P_{SPT,X}. Via the feedforward control value and a second correction factor K_{Xϑ}, the phase angle Δ_{ϑ} calculated by the droop controller is directly adapted to a changed plant setpoint P_{SPT,POI}. This increases the dynamics and reduces the tendency to oscillate.

The individual fractions P_{SPT,POI,X} of the plant setpoint P_{SPT,POI} are transmitted by the plant controller 28 to the respective inverters 10.X. This corresponds to the power setpoint of the inverter 10.X which is normalized to its relative nominal power from the plant setpoint P_{SPT,POI}. This makes possible the realization of feedforward control for rapid implementation of the power setpoint specifications at the grid connection 26. In addition, fast setpoint tracking behavior is made possible for the individual exchange power P_{INV,X} and thus the total exchange power P_{POI}.

Via the first correction factor K_{XP} and the second correction factor K_{Xϑ}, the feedforward control paths can be weighted against each other.

The amplitude and rate of change of the feedforward control can be limited by additional limiting elements. This can reduce or prevent sudden changes and overshoots and improve damping of the excitation of resonances.

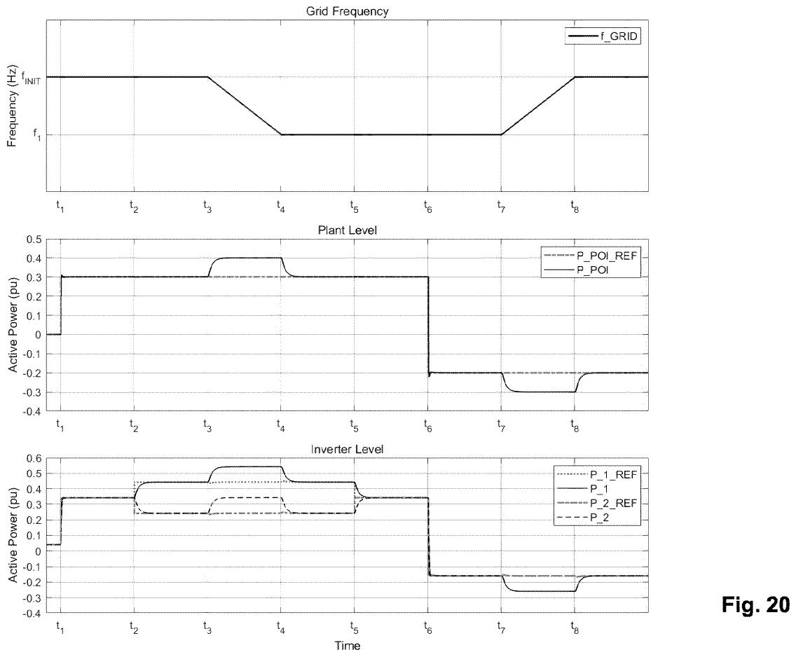

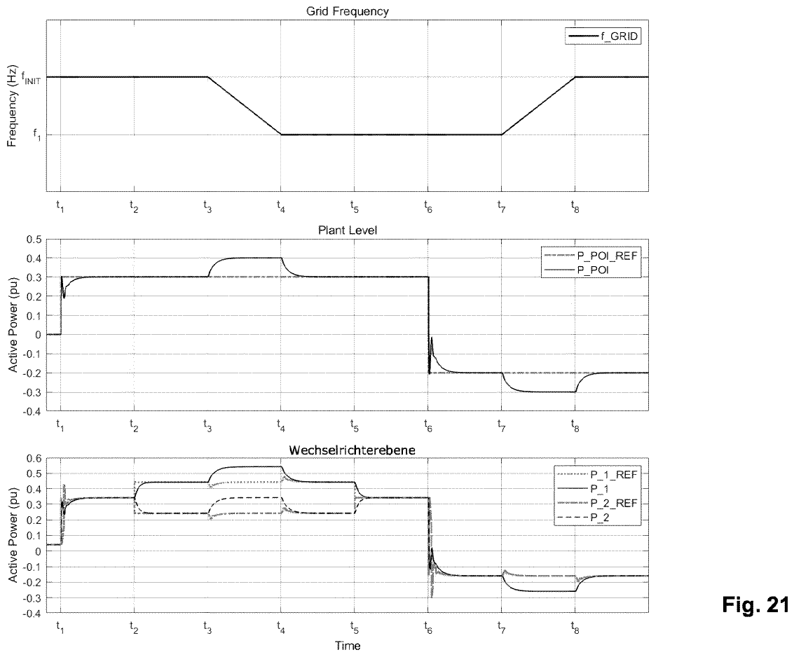

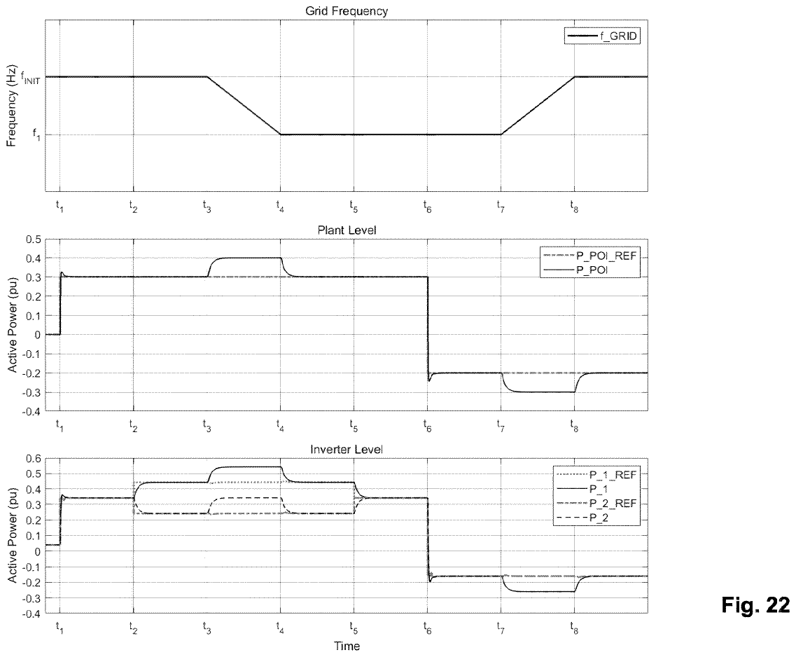

FIGS. 20 to 22 show by way of example time profiles of the setpoint and actual values for an energy supply plant 11 and its inverters 10.1, 10.2 when the method according to FIG. 10 is used, wherein in FIG. 20, no communication delay is assumed, and in FIG. 21, a significant communication delay of the transmission of the exchange power P_{INV,X} of the inverters 10.1, 10.2 to the plant controller 28 is assumed, and wherein the communication delay in FIG. 22 is taken into account by means of a delay element 36 (see FIG. 9).

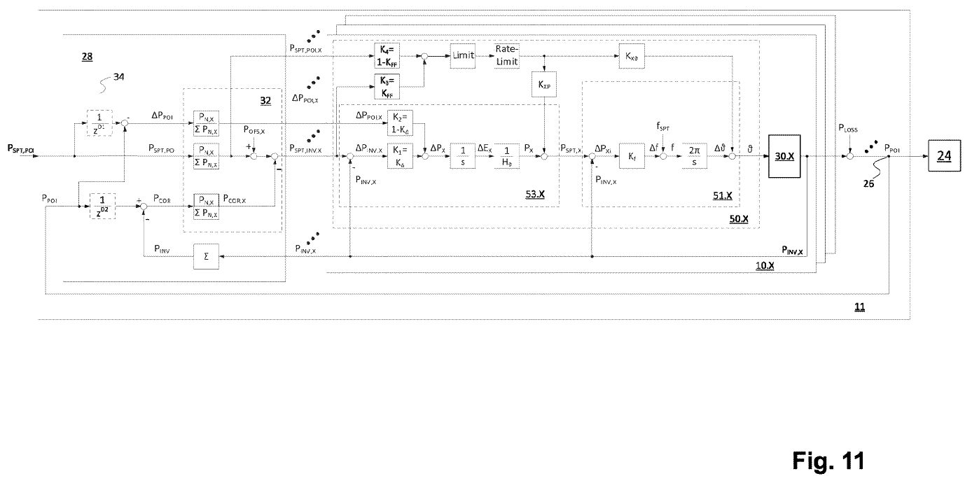

FIG. 11 shows by way of example an embodiment of the energy supply plant 11 in which various embodiments have been combined. In the embodiment according to FIG. 11, the double feedforward control of the inertia-generating control 53.X and of the droop control 51.X shown in FIG. 10 is also modified in such a way that the feedforward control value is calculated by a weighted sum of the individual fraction of the inverter in the plant setpoint P_{SPT,POI,X} and of the individual inverter power setpoint P_{SPT,INV,X}. The weighted sum is calculated using two correction factors (K₃, K₄), the sum of which is preferably equal to one.

Other combinations of the illustrated embodiments are also possible, in particular with the use of an asymmetry static 55.X, 57.X in the inertia-generating control 53.X and/or in the droop control 51.X.

The embodiments shown in the figures offer satisfactory functionality with regard to the setpoint tracking behaviour and the disturbance behavior of the energy supply plant 11 despite possible communication-related delays in the transmission of required data between the inverter 10.X and the plant controller 28. Even if there are any differences in the delay on different transmission channels, the tendency to oscillation is kept low. This applies in particular to the embodiment in FIG. 11 or 12 where a plurality of functionalities are implemented together.

It is in particular advantageous that in the embodiment of FIG. 11 where the individual functions from FIGS. 4 to 10 are implemented in combination, a decoupling of the individual functions is still provided. This serves to reduce adverse interactions between them and results in a reduction in the tendency to oscillate and, associated therewith, an improvement in the adjustment speed.

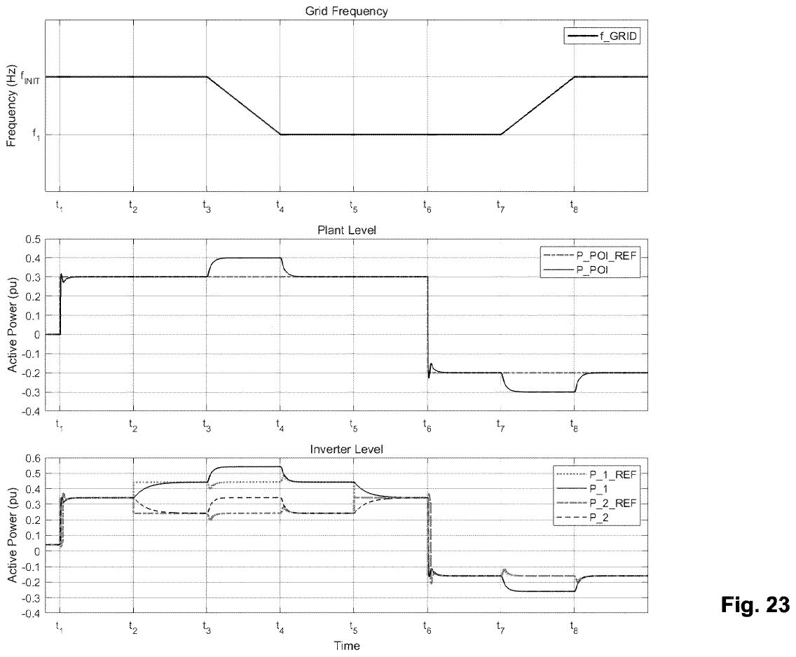

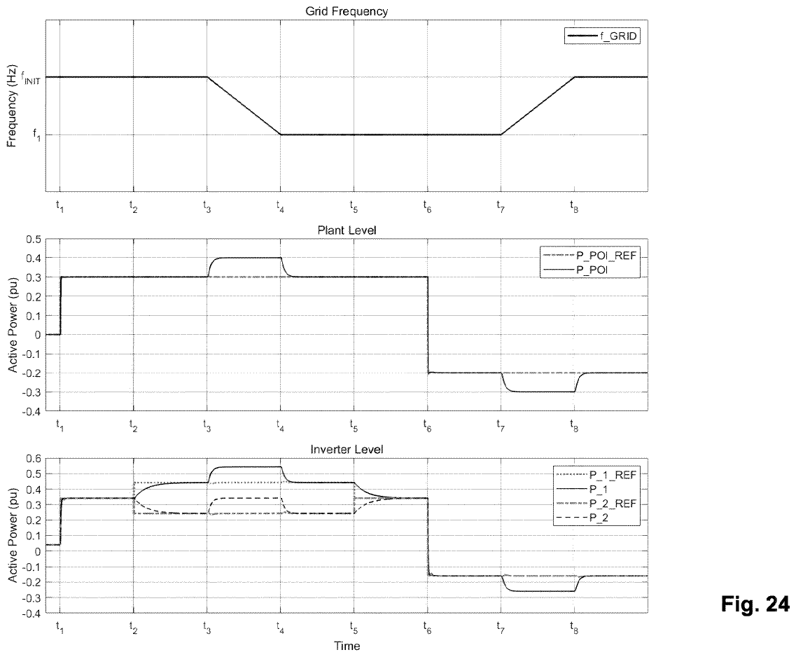

FIGS. 23 and 24 show by way of example time profiles of the setpoint and actual values for an energy supply plant 11 and its inverters 10.1, 10.2 when the method according to FIG. 11 in different variants is used.

In the following FIGS. 12 to 24, time profiles of setpoints and actual values are shown of powers P_{POI} at a grid connection point 26 and of powers P_{INV,X} at individual inverters 10.X of an energy supply plant 11. Based on these figures, various properties of the controllers according to FIGS. 1 to 11 are discussed in the following. Without any loss of generality, an exemplary energy supply plant 11 is considered that comprises exactly two inverters 10.1, 10.2. The powers of the inverters 10.1, 10.2 are controlled by their respective controllers 50.1, 50.2, which in turn are influenced by the plant controller 28, so that the total exchange power of the energy supply plant 11 with the grid 24 is controlled by the plant controller 28, and an instantaneous reserve power is provided at the grid connection 26. The energy supply plant 11 may comprise further sinks or sources whose influence is combined in a power loss P_{LOSS}, for example components such as transformers, cables, auxiliary units or smaller generating units that are not controlled by the plant controller.

The upper graph (“Grid Frequency”) in FIGS. 12 to 24 shows an example time profile of the grid frequency of the grid 24, referred to here as “f_GRID”. The middle graph (“Plant Level”) shows the time profiles of the plant setpoint P_{SPT,POI}, here referred to as P_POI_REF, and of the total exchange power P_{POI}, here referred to as P_POI. The lower graph (“Inverter Level”) shows the time profiles of the two individual inverter power setpoints P_{SPT,INV,X}, here referred to as P_1_REF and P_2_REF, and of the two corresponding individual exchange powers P_{INV,X}, here referred to as P_1 and P_2. P_1_REF and P_2_REF thus represent the setpoints, and P_1 and P_2 the actual values of the inverters 10.1 and 10.2 of the energy supply plant 11 whose power setpoint P_POI_REF is basically distributed between the setpoints P_1_REF and P_2_REF and whose total power P_POI at the grid connection point 26 basically comprises the powers P_1 and P_2.

FIGS. 12 to 24 show resulting time profiles when various embodiments of the method according to the application are applied in the energy generation plant 11. Active power is shown by way of example, wherein the active powers are normalized to the nominal power of plant 11 as a whole (Plant Level, middle image in each case) or to the nominal power of the respective individual inverters 10.1, 10.2 (Inverter Level, lower image) (unit “pu”=“per unit”).

The time profiles of the grid frequency f_GRID and of the plant setpoint P_POI_REF are identical in FIGS. 12 to 24. In addition, identical individual offset values P_{OFS,X} (not shown) act on the distribution of the plant setpoint P_POI_REF to the individual inverter power setpoints P_1_REF and P_2_REF.

The time profiles in FIGS. 12 to 24 have the following sections, each with specific boundary conditions:
t<t₁: the grid frequency f_GRID corresponds to a nominal frequency f_{INIT} of the grid 24 and is, for example, 50 Hz; the plant setpoint P_POI_REF and the offset values P_{OFS,X} are equal to zero.
t₁<t<t₂: the grid frequency f_GRID continues to correspond to the nominal frequency f_{INIT} of the grid 24; the plant setpoint P_POI_REF is +0.3 pu; the offset values P_{OFS,x} are still zero.
t₂<t<t₃: the grid frequency f_GRID continues to correspond to the nominal frequency f_{INIT}; the plant setpoint P_POI_REF remains +0.3 pu; the offset value P_{OFS,1} for inverter 10.1 has changed from zero to +0.1 pu, the offset value P_{OFS,2} for the inverter 10.2 has changed from zero to −0.1 pu.
t₃<t<t₄: the grid frequency f_GRID decreases at a constant rate from the nominal frequency f_{INIT} to a smaller value f₁; the plant setpoint P_POI_REF remains +0.3 pu; the offset values P_{OFS,x} remain +0.1 pu and −0.1 pu.
t₄<t<t₅: the grid frequency f_GRID has the reduced value f₁ compared to the nominal frequency f_{INIT}; the plant setpoint P_POI_REF remains +0.3 pu; the offset values P_{OFS,x} remain +0.1 pu and −0.1 pu.
t₅<t<t₆: the grid frequency f_GRID continues to have the reduced value f₁; the plant setpoint P_POI_REF remains +0.3 pu; the offset values P_{OFS,X} have changed from +/−0.1 pu to zero.
t₆<t<t₇: the grid frequency f_GRID continues to have the reduced value f₁; the plant setpoint P_POI_REF has changed to −0.2 pu; the offset values P_{OFS,x} are still zero.
t₇<t<t₈: the grid frequency f_GRID increases at a constant rate from the frequency f₁ to the nominal frequency f_{INIT}; the plant setpoint P_POI_REF remains −0.2 pu; the offset values P_{OFS,x} are still zero.
t>t₈: the grid frequency f_GRID corresponds to the nominal frequency f_{INIT} of the grid 24; the plant setpoint P_POI_REF remains −0.2 pu; the offset values P_{OFS,x} are still zero.

FIG. 12 shows the behavior of an energy generation plant 11 with a conventional controller according to FIG. 1, in which the controller 20.X is designed as voltage-impressing and the total exchange power P_POI is processed in the plant controller 28 by means of the controller 15. The controller 15 is designed as an integral controller or as a proportional-integral controller and controls the deviation between the total exchange power P_POI and the plant setpoint P_POI_REF towards zero by accordingly modifying the plant setpoint P_POI_REF in the event of such deviations, passing it on to the dispatcher 16 where, taking into account the offset values P_{OFS,X}, it is distributed to the inverter power setpoints P_1_REF, P_2_REF.

FIG. 12 shows that by the amplification of the integral component in the controller 15 of the plant controller 28, fast setpoint tracking behavior in the event of changes in the plant setpoint P_POI_REF and a fast correction of the control error of the total exchange power P_POI is achieved; see in particular the profile of the total exchange power P_POI at times t₁ and t₆. On the other hand, the profile of the total exchange power P_POI at times t₁ and t₆ reveals a clear overshoot.

Another disadvantage of the behavior according to FIG. 12 of the energy generation plant 11 with a controller according to FIG. 1 is that the reactions of the voltage-impressing controllers 20.X in the case of a frequency change between t₃ and t₄ or between t₇ and t₈ are perceived by the plant controller 28 as a control deviation at the grid connection 28 and are adjusted on the basis of the integral component in the controller 15 by changing the individual inverter power setpoints P_1_REF, P_2_REF. In FIG. 12, shortly after the times t₃ or t₇, the total exchange power P_POI therefore again corresponds to the plant setpoint P_POI_REF.

FIG. 13 shows the behavior of an energy generation plant 11 with the controller according to FIG. 3 or FIG. 4 in which, in particular in comparison to the controller according to FIG. 1, no controller 15 with integral components is used in the plant controller 28. Instead, a control deviation between the total exchange power P_POI and the plant setpoint P_POI_REF is corrected in the plant controller 28, taking into account the measured individual exchange powers P_1, P_2 of the inverters 10.1, 10.2 transmitted to the plant controller 28 and the measured or determined total exchange power P_POI, in that the individual inverter power setpoints P_1_REF, P_2_REF are adapted in the dispatcher 32, additionally taking into account the respective offset values P_{OFS,X}. This results in high steady-state power precision not only at the inverters 10.1, 10.2 but also at the grid connection 26. The settling behavior after a change in the plant setpoint P_POI_REF itself or of the inverter power setpoints P_1_REF, P_2_REF when changing the offset values P_{OFS,X} depends on the parametrization of the gridforming controller 50.X in the inverters 10.1, 10.2, in the embodiment according to FIG. 4, for example, on the inertia factor 1/H_{ϑ}, so that the higher an inertia constant Ha the slower a response to the changed setpoint.

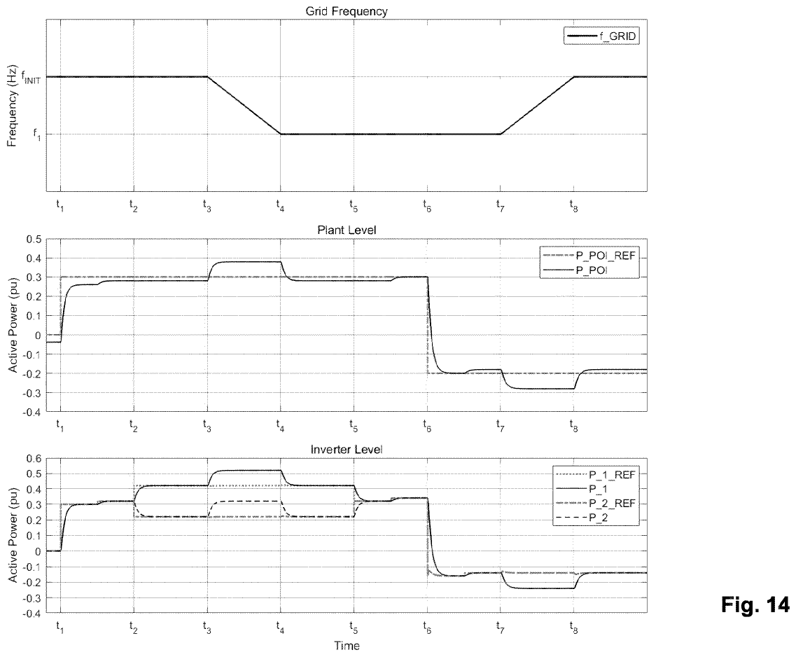

FIG. 14 shows the behavior of an energy generation plant 11 with the controller according to FIG. 4 in which an optional gain factor Kc is used in the dispatcher 32 of the plant controller 28 to calibrate the measured values P_POI and/or P_1, P_2. This allows the fractions of the inverters 10.1, 10.2 of the plant power setpoint P_POI_REF, that are determined, normalized, and optionally offset in the dispatcher 32, to be corrected by a settable, normalized control deviation between the total exchange power P_POI and the plant setpoint P_POI_REF, in particular to compensate, if necessary, for any measurement inaccuracies at the inverters 10.1, 10.2 and/or at the grid connection 26 with settable weighting. At time t₁, the gain factor K_{c} initially has the value 0, i.e. a given deviation of the sum of the exchange powers P_1, P_2 of the inverters 10.1, 10.2 from the total exchange power P_POI is not compensated. In the middle between t₁ and t₂ the gain factor K_{c} is changed from 0 to 0.5. This reduces the deviation of the total exchange power P_POI and the plant setpoint P_POI_REF for a given power loss P_{LOSS}, which, however, remains undercompensated. In the middle between t₅ and t₆ the gain factor K_{c} is changed from 0.5 to 1 so that the power loss P_{LOSS} is exactly compensated, and the total exchange power P_POI in the steady state corresponds to the plant setpoint P_POI_REF. In the middle between t₆ and t₇ the gain factor K_{c} is changed from 1 to 1.5, so that the deviation of the sum of the exchange powers P_1, P_2 of the inverters 10.1, 10.2 from the total exchange power P_POI is overcompensated. This example is idealized in that no measurement inaccuracies occur and therefore the power loss P_{LOSS} is precisely compensated with a gain factor K_{c} with the value 1.

The use of the controller from FIG. 4 is suitable for energy supply plants 11 having low communication delays in the transfer of information between the plant controller 28 and the inverters 10.X. However, if for example the feedback of the actual power values P_1, P_2 to the plant controller 28 is delayed, oscillations may occur, and the command and disturbance behavior may be slowed down overall.

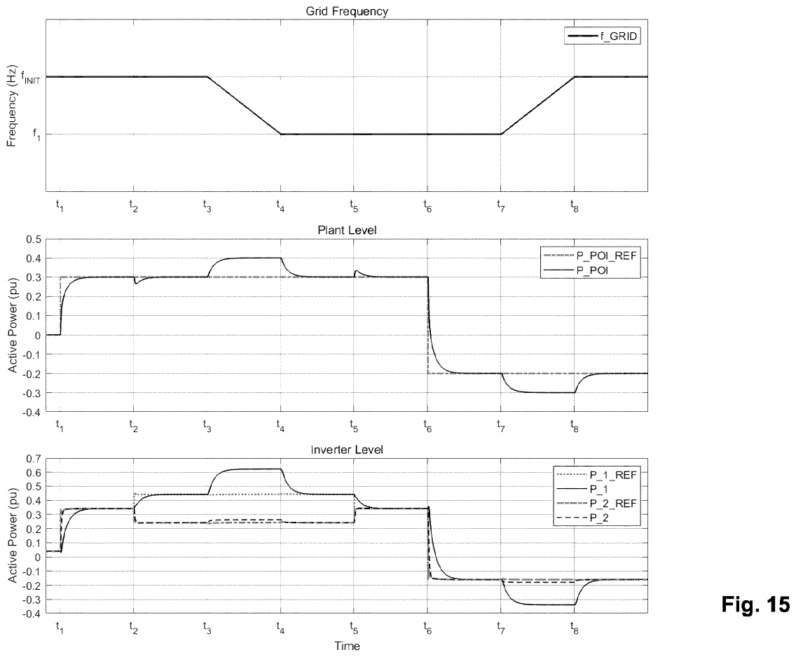

FIG. 15 shows the behavior of an energy generation plant 11 in which the inverters 10.1, 10.2 each have a gridforming controller 50.X which is designed, for example, according to FIG. 4, wherein the inverters 10.1 and 10.2 use different inertia factors 1/H_{ϑ}. As a result, the inverter 10.1 reacts to the frequency changes between t₃ and t₄ or between t₇ and t₈ with a significant symmetrical change in its exchange power P_1, while the inverter 10.2 shows practically no reaction to the frequency changes between t₃ and t₄ or between t₇ and t₈. The energy generation plant 11 as a whole therefore generates a symmetrical instantaneous reserve power at the grid connection 26, which essentially consists of the symmetrical contribution of the inverter 10.1 and in particular counteracts a grid frequency gradient.

FIGS. 16 and 17 show the behavior of an energy generation plant 11 with a controller according to any one of FIGS. 5 to 7, wherein by different settings of the asymmetry statics 55.X and/or 57.X in the controllers 50.1, 50.2 of the inverters 10.1. 10.2, different asymmetric instantaneous reserve powers are provided by the inverters 10.1. 10.2, which in turn result in an asymmetrical (FIG. 16) or symmetrical (FIG. 17) instantaneous reserve power of the energy generation plant 11 at the grid connection 26.

FIG. 16 shows the behavior of an energy generation plant 11 in which the inverters 10.1, 10.2 have identical asymmetry statics which are configured in such a way that the inverters 10.1, 10.2 and therefore the energy generation plant as a whole provide asymmetric instantaneous reserve power. Specifically, the asymmetry statics are set such that the inverters 10.1, 10.2 respond to the positive grid frequency gradient between t₇ and t₈ with a significantly larger change in the exchange powers P_1 and P_2 than to the negative grid frequency gradient between t₃ and t₄. This behavior can be in particular advantageous in order to provide an overall asymmetric instantaneous reserve power by means of the energy generation plant.

FIG. 17 shows the behavior of an energy generation plant 11 in which the inverters 10.1, 10.2 have different asymmetry statics which are configured in such a way that the inverters 10.1, 10.2 provide asymmetric instantaneous reserve power in mirror symmetry to each other, such that the energy generation plant as a whole in turn provides symmetric instantaneous reserve power. Specifically, the asymmetry static of the controller 50.1 of the inverter 10.1 can be set such that the inverter 10.1 reacts to the negative grid frequency gradient between t₃ and t₄ with a significantly larger change in the exchange power P_1 than to the positive grid frequency gradient between t₇ and t₈, while the inverter 10.2 reacts in an opposing manner, i.e. with a significantly larger change in the exchange powers P_2 in case of a positive grid frequency gradient between t₇ and t₈ than in case of a negative grid frequency gradient between t₃ and t₄. In particular with regard to the grid frequency changes, the total exchange power P_POI changes by the same magnitude independently of the sign of the grid frequency gradient, so that the energy generation plant 11 as a whole provides a symmetrical instantaneous reserve power.

The behavior according to FIG. 17 can be advantageously applied in particular in an energy generation plant 11 whose inverters 10.1, 10.2 can at least partly provide asymmetric instantaneous reserve power only, e.g. due to restrictions of the energy generators or consumers connected to the inverters 10.1, 10.2, which e.g. can freely change their electrical exchange power essentially in one direction only. Such an energy generation plant 11 can nevertheless provide overall symmetrical instantaneous reserve power by means of the method according to the application, in that asymmetrical behavior of individual inverters 10.1 is compensated by mirror-image asymmetrical behavior of other inverters 10.2 of the energy generation plant 11.

The fluctuations arising in FIGS. 15 and 16 at times t₂ and t₅ in the total exchange power P_POI are caused by a different behavior of the inverters 10.1, 10.2 in terms of magnitude when changing the offset values P_{OFS,1} and P_{OFS,2} and are undesirable per se since only the distribution of the plant setpoint P_{SPT,POI} to the inverters 10.1, 10.2 is supposed to change while the plant setpoint P_{SPT,POI} remains constant and the total exchange power P_POI should remain accordingly constant. Such undesirable fluctuations in the total exchange power P_POI can be reduced in particular by means of a feedforward control according to FIG. 11.

FIG. 18 shows the behavior of an energy generation plant 11 with a controller according to FIG. 9, in which possible communication delays can be taken into account in the plant controller 28 by means of a delay element 36 with the delay constant D2 in order to equalize the communication delays in the transmission of the actual power values P_1, P_2 and the total exchange power P_POI. This significantly reduces in particular oscillations when the plant setpoint P_POI_REF changes.

FIG. 19 shows the behavior of an energy generation plant 11 with a controller according to FIG. 8, in which—alternatively or in addition to the delay element 36 according to FIG. 9—the individual power control deviation ΔP_{INV,X} in the inertia-generating control 53.X of the inverter 10.X is corrected to a settable degree by the individual deviation fraction ΔP_{POI,X} of the respective inverter 10.X in the plant deviation ΔP_{POI}. As a result, the tendency to oscillate can be further reduced and the setpoint tracking behavior be improved, even in the event of significant communication delays, in particular when the plant setpoint P_POI_REF changes.

FIG. 20 shows the behavior of an energy generation plant 11 with a controller according to FIG. 10, in which a feedforward control, which intervenes with adjustable weighting in the respective inertia-generating controller 53.X and in the respective droop controller 51.X as provided by the plant controller 28, further improves both the dynamics and the setpoint tracking behavior of the controller. In the absence of significant communication delays in the energy supply plant 11, the plant setpoint P_POI_REF is divided amongst the inverters 10.1, 10.2 with high steady-state power precision, wherein high steady-state power precision at the grid connection 26 is achieved by the feedback of both the total exchange power P_POI and the individual exchange powers P_1, P_2 of the inverters 10.1, 10.2 to the plant controller 28. In particular, the feedforward control achieves high dynamics when the plant setpoint P_POI_REF changes, and the setpoint tracking behavior of the energy supply plant 11 is further improved. The dynamics in case of changes in the power distribution between the inverters 10.1, 10.2 as well as in case of frequency changes in the grid frequency is determined by the inertia as configured in the inertia-generating controls 53.X in the inverters 10.X.

FIG. 21 shows the behavior of the energy generation plant 11 with the controller according to FIG. 10, whereby, in contrast to FIG. 20, there is a significant communication delay in the transmission of the exchange powers P_1, P_2 from the inverters 10.1, 10.2 to the plant controller 28. As a result, in case of changes in the plant setpoint P_POI_REF, for example at times t₁ and t₆, oscillations of the exchange powers P_1, P_2 occur again, in particular a dynamic undershoot, which may also propagate into the total exchange power P_POI. In addition, the setpoint tracking and disturbance response behavior and thus the settling behavior of the energy supply plant 11 are slowed down overall.

FIG. 22 shows the behavior of the energy generation plant 11 with the controller according to FIG. 10 when there is a significant communication delay, wherein the communication delays are additionally taken into account in the plant controller 28 by applying a delay element 36 to the measured or determined total exchange power P_POI according to FIG. 6.

FIG. 23 shows the behavior of the energy generation plant 11 with the controller according to FIG. 11 when there is a significant communication delay and with a correction of the individual power control deviation ΔP_{INV,X} in the inertia-generating control 53.X using K₁=0.3 and K₂=0.7, but without a delay by the delay element 34.

FIG. 24 shows the behavior of the energy generation plant 11 with the controller according to FIG. 11 when there is a significant communication delay, wherein in contrast to FIG. 21, the communication delays are additionally taken into account in the plant controller 28 by applying a delay element 36 to the measured or determined total exchange power P_POI according to FIG. 6.

What is claimed is:

1. A method for operating an energy supply plant having a plurality of inverters and a plant controller, which is in communicative connection with the inverters,
wherein the energy supply plant has a grid connection which is connected to an AC voltage grid, and wherein the inverters exchange electrical exchange powers with the AC voltage grid via the grid connection, so that so that the energy supply plant exchanges a total exchange power with the AC voltage grid which comprises the respective electrical exchange powers,
wherein the plant controller is configured to determine individual inverter power setpoints depending on a plant setpoint for the total exchange power of the energy supply plant,
wherein the plant controller is further configured to transmit the individual inverter power setpoints to controllers of the inverters,
wherein the respective controllers of the inverters are configured to set the respective exchange powers of the inverters depending on the inverter power setpoints,
wherein the controllers of the inverters are configured for gridforming, and the inverters are configured to provide individually settable instantaneous reserve power.

2. The method according to claim 1, wherein measured individual exchange powers of the respective inverters are transmitted to the plant controller, and the plant controller is configured to continuously redetermine inverter power setpoints (P_{SPT,INV,X}) depending on measured exchange powers (P_{INV,X}) and transmits them to the inverters.

3. The method according to claim 1, wherein the plant controller is configured to determine the inverter power setpoints (P_{SPT,INV,X}) in that a plant setpoint (P_{SPT,POI}) is normalized to a respective relative nominal power of the respective inverter and an individual offset value (P_{OFS,x}) is added, wherein a sum of offset values (P_{OFS,X}) yields the value zero.

4. The method according to claim 1, wherein the grid-forming controllers are configured to react autonomously with an individually settable power response to grid events, and each comprise a droop control and an inertia-generating control.

5. The method according to claim 4, wherein the inverters are configured to set their respective exchange powers (P_{INV,X}) by means of a respective droop control with the aid of a droop characteristic, depending on a droop characteristic reference power (P_{SPT,X}), and a respective voltage profile deviation of a voltage profile of a grid voltage from a respective reference profile based on a droop setpoint (X_{SPT}), wherein the droop setpoint (X_{SPT}) comprises a frequency setpoint (f_{SPT}) and/or a setpoint voltage amplitude (U_{SPT}), wherein the voltage profile deviation of the voltage profile is a phase angle difference (Δϑ) between the phase angle (ϑ) of an inverter output voltage and of the grid voltage or an amplitude difference between an amplitude of the inverter output voltage and of the grid voltage, and wherein the phase angle difference (Δϑ) or the amplitude difference is represented by a respective exchange power (P_{INV,X}).

6. The method according to claim 4, wherein the inverters use the inertia-generating control to vary an input value of the droop control, the input value being a droop characteristic reference power (P_{SPT,X}), depending on an individual power deviation (ΔP_{INV,X}) of the exchange power (P_{INV,X}) of the respective inverter from the inverter power setpoints (P_{SPT,INV,X}), in order to set the exchange power (P_{INV,X}) of the inverters to the respective inverter power setpoint (P_{SPT,INV,X}).

7. The method according to claim 4, wherein the grid-forming controllers comprise a sign-dependent weighting of a deviation of an individual exchange power (P_{INV,X}) from the respective power setpoint (P_{SPT,INV,X}, P_{SPT,X}), wherein the grid-forming controllers comprise an asymmetry static which weights the deviation of the individual exchange power (P_{INV,X}) from the respective power setpoint (P_{SPT,INV,X}, P_{SPT,X}) differently depending on the sign of a voltage profile deviation, wherein a weighting for the different signs of the voltage profile deviation differs by at least a factor of 2.

8. The method according to claim 7, wherein in the droop control, the respective exchange power (P_{INV,X}) is used as a measure of the voltage profile deviation, and a respective deviation of the exchange power (P_{INV,X}) from the droop characteristic reference power (P_{SPT,X}) is weighted with a respective droop asymmetry static.

9. The method according to claim 7, wherein in the inertia-generating control, the individual power deviation is weighted with a respective inertia asymmetry static.

10. The method according to claim 4, wherein power control dynamics of the droop control are faster than the power control dynamics of the inertia-generating control so that the setting of the exchange power (P_{INV,X}) by the droop control in case of a phase angle difference (Δϑ) is faster than a variation of the droop characteristic reference power (P_{SPT,X}) by the inertia-generating control in case of an individual power deviation (ΔP_{INV,X}) of the measured individual exchange power (P_{INV,X}) from the inverter power setpoint (P_{SPT,INV,X}), if this power deviation (ΔP_{INV,X}) is caused by a reaction to a phase angle difference (Δϑ).

11. The method according to claim 1, wherein the total exchange power (P_{POI}) of the energy supply plant is determined and, in the plant controller, a total power deviation (P_{COR}) of the total exchange power (P_{POI}) from the sum of the measured exchange powers (P_{INV,X}) of the inverters is determined and normalized to respective relative nominal powers (P_{N,X}) of the respective inverters, and the normalized partial power deviations (P_{COR,X}) thus determined are taken into account in the plant controller when determining individual inverter power setpoints (P_{SPT,INV,X}).

12. The method according to claim 4, wherein the respective inertia-generating controllers vary the droop characteristic reference power (P_{SPT,X}) of the droop controller using a feedforward control with a product of an individual feedforward control value and a first correction factor (K_{XP}).

13. The method according to claim 12, wherein the respective droop controllers determine a phase angle (ϑ) of an output voltage of the inverter using a feedforward control with the product of the individual feedforward control value and a second correction factor (K_{Xϑ}).

14. The method according to claim 12, wherein the individual feedforward control value is formed by an inverter's individual fraction of the plant setpoint (P_{SPT,POI,X}) or by a weighted sum of the inverter's individual fraction of the plant setpoint (P_{SPT,POI,X}) and the individual inverter power setpoint (P_{SPT,INV,X}), wherein the weighted sum is formed using two correction factors (K₃, K₄), the sum of which is equal to 1.

15. The method according to claim 4, wherein an input value of the droop control, the input value being the droop characteristic reference power (P_{SPT,X}) is varied within the inertia-generating control depending on the product of a first weighting factor (K₁) and the power deviation (ΔP_{INV,X}) of the respective inverter from the inverter power setpoint (P_{SPT,INV,X}).

16. The method according to claim 15, wherein the input value of the droop control, the input value being the droop characteristic reference power (P_{SPT,X}), is varied depending on the product of a second weighting factor (K₂) and the inverter's individual fraction of a plant deviation (ΔP_{POI,X}).

17. The method according to claim 16, wherein an input value of the inertia-generating controller is formed from a sum of an individual power deviation (ΔP_{INV,X}) and the individual fraction of the plant deviation (ΔP_{POI,X}), each weighted by the respective weighting factor (K₁, K₂), wherein the sum of the first weighting factor (K₁) and the second weighting factor (K₂) yields the value one.

18. The method according to claim 1, wherein the electrical powers controlled by the method are pure active powers or pure reactive powers, and/or wherein the electrical powers controlled by the method represent a positive-sequence plant power or a negative-sequence plant power, and/or wherein the electrical powers controlled by the method are represented by active currents or reactive currents in positive-sequence plant components and/or in negative-sequence plant components.

19. An energy supply plant comprising a plurality of inverters and a plant controller which is in communicative connection with the inverters, wherein the energy supply plant is configured to be operated by a method according to claim 1.

20. The energy supply plant according to claim 19, wherein the controllers of the inverters each have an asymmetry static and are configured to provide an individually settable symmetrical or asymmetrical instantaneous reserve power on an inverter level, wherein the energy supply plant is configured to provide a settable symmetrical or asymmetrical instantaneous reserve power at the grid connection.

21. An inverter with a grid-forming controller which comprises a droop controller and a superimposed inertia-generating controller for changing an input value of the droop controller, in particular a droop characteristic reference power (P_{SPT,X}), wherein the inverter is configured for use in an energy supply plant comprising a plurality of inverters and a plant controller which is in communicative connection with the inverters, wherein the energy supply plant is configured to be operated by a method according to claim 1.
